(19) United States
(12) Patent Application Publication
(10) Pub. No.: US 2003/0130900 A1
(43) Pub. Date: Jul. 10, 2003

(54) Internet-based system and method for electronically fulfilling purchase orders for chemical and plastic products

(76) Inventors: Ian G. Telford, Adliswil (CH); Mack D. Murrell, Midland, MI (US); Phillip H. Cook, Midland, MI (US); Philippe Raynaud de Fitte, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/044,051

(22) Filed: Jan. 10, 2002

(51) Int. Cl. G06F 17/60

(52) U.S. Cl. 705/26

(57) ABSTRACT

An Internet-based, web-based computerized system and method of buying and selling a commodity-type product useful in manufacturing and processing industries including the steps of:

(a) providing a web site system offering products that includes a browsable catalog of the products and provides services for allowing customers to electronically choose and purchase the products at a pre-established price and on a self service basis a 24 hour per day, 7 day per week, 365 days per year basis (excluding acceptable network and system downtime);

(b) requiring the customer to agree to an initial purchase agreement for said products, said purchase agreement containing a first set of pre-established terms and conditions and a second set of surcharge-bearing terms and conditions which are activated and implemented upon the purchaser requesting modification of the first set of terms and conditions after the initial purchase order is submitted electronically by the customer and accepted by the manufacturer of said products;

(c) transacting a sale of the product and/or other products of the catalog with the customer through the web site system; and

(d) completing the transaction by fulfilling the purchase order based on the initial purchase agreement or any modification thereof.

The present portiche system and method of the present invention utilizes the Internet and web site to market and sell products on a global basis; and allows buyers, manufacturers and distributors of goods, particularly in the chemical, plastic and process industries, to conveniently participate in the e-commerce marketplace with minimal disruption to existing direct and distribution channels.

### FIELD OF THE INVENTION

The present invention relates generally to electronic commerce and electronic transactions, and more particularly, the present invention relates to an Internet-based, web-based computerized method of buying and selling a commodity-type product useful in manufacturing and processing industries.

### BACKGROUND OF THE INVENTION

The Internet comprises a vast number of computers and computer networks that are interconnected through communication links. The Internet has emerged as a large community of electronically-connected users located around the world who readily and regularly exchange significant amounts of information. The Internet is especially conducive to conducting electronic commerce.

Many web servers have been developed through which vendors can advertise and sell products. The products can include items (e.g. music) that are deliverable electronically to the purchaser over the Internet and items (e.g. books) that are delivered through conventional distribution channels (e.g. common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming web page to the client computer system and schedules shipment of the items. U.S. Pat. No. 5,960,411, for example, discloses a computer method and system for placing an order and ordering items over the Internet. U.S. Pat. No. 6,029,141 provides a glossary of terms and acronyms commonly used by those skilled in the art to which the present invention pertains, including definitions for terms such as “Internet”, “world wide web”, “Hyper Text Markup Language (HTML)”, “Hyper Text Transport Protocol (HTTP)”, and others. U.S. Pat. Nos. 5,960,411 and 6,029,141 are incorporated herein by reference.

While the Internet is considered a new marketplace for many products and services, particularly information products that can be physically transferred via the Internet such as articles, software, cartoons, etc., there are some products such as bulk chemicals which have heretofore been sold and purchased by traditional systems such as by telephone, by fax or by personal contact. The chemical and other commodity industries currently use various conventional or traditional channels to market including direct sales or distribution via distributors or retailers. Off-line purchasing involves calling different suppliers for a specified amount and type of product such as a chemical or a plastic, weighing the offers, and then ordering the material from one of the suppliers.

When a customer is seeking to purchase chemicals from a manufacturer/supplier, the customer usually buys with standard (geographically) locally accepted terms and conditions using a varying set of non-standardized business rules, and after negotiating a short or long-term supply contract. In the normal course of business, for example, this type of transaction requires person-to-person negotiations, a sales contract in paper-form and a shipping mechanism for bulk chemical products. Bulk chemicals have heretofore required the traditional systems because of the nature of the product requiring shipment, for example, in tank cars and railroad cars. These type of items are not one that a customer can pick up and carry away with them when purchased. The chemicals have to be delivered. The present invention is concerned with selling and purchasing of these type of large quantity, commodity type chemicals.

One of the main reasons a potential customer did not have a means for buying bulk chemicals over the Internet is because traditionally a customer had to negotiate a supply agreement and order large quantities in tank cars. The transaction typically involved long drawn out negotiation by person-to-person contact or by telephone for a supply contract. The supply contract had to be established for a long period of time, include large quantities of product, have set rules, and then the deal had to be profitable for everyone in the supply chain, including the supplier, transporter, etc. The customer typically could back out of a good deal. In addition, there are several intermediaries, hubs, portals or matchmakers started web-based businesses which offer only a transaction medium for purchasers and sellers but without owning product themselves, often leading to issues of lack of product and financial liquidity and non-availability of product or inefficient supply chains. Clearly, the current systems are inefficient for both the purchaser and supplier.

Therefore, what is needed in the chemical industry is a system and method which allows customers, who are price buyers and require a lower cost, an easy way to purchase commodity type products such as epoxy resins over the Internet without a paper transaction, without negotiations, with no frills, with no technical service and development (TS&D), but with consistent high quality service and reliably accurate delivery, longer lead-times, an automatic order entry system for purchase orders; and allows the customer to choose a contract and spot price.

Accordingly, it is desired to provide a means for the sale and purchase of chemicals and plastics over the Internet to make the transaction paperless, i.e. without the use of paper orders or confirmations; to carry out the transaction without the use of TS&D; and to provide a transaction that is simple, efficient, and cost effective.

### OBJECTS OF THE INVENTION

Accordingly, it is an object of the present invention to provide a system and method for improving upon the prior systems and methods of selling and purchasing chemical and plastic products.

It is another object of the present invention to make available for sale a significantly greater selection of chemical products than has previously been readily ascertainable.

It is another object of the present invention to make available for sale products and services on a 24 hour/day, 7 day/week, 365 days/year basis (excluding acceptable network and system downtime) and allow suppliers and customers to access information and services on the site on an electronic self-service basis.

It is also an object of the present invention to provide a prospective purchaser with a large selection of products that conforms to the specifications of the prospective purchaser and are of interest to the prospective purchaser; and thereby facilitate a reduction in the time required to find desired products.

It is a further object of the present invention to increase sales potential of a manufacturer as a supplier by making the products available for immediate purchase by the customer without any verbal negotiations.

It is a further object of the present invention to increase sales potential of a manufacturer as a supplier by making the products available globally, in regions of the world in which the manufacturer might not have a significant commercial presence as well as increasing said manufacturer's access to the market and increasing speed of sales and purchasing processes.

It is yet another object of the present invention to provide other suppliers with ready access to one or more web sites and pages without requiring additional web sites and pages or investment in creating a new web sites and pages and related costs.

It is a still further object of the present invention to enable suppliers to electronically market their chemicals and electronically consummate transactions involving such products on a worldwide basis through a choice of manual and automatic processes, including e-mail, ERP (Enterprise Resource Planning) to ERP, Internet browser to ERP, EDI (Electronic Data Interchange), using XML (Extensible Mark-up Language), CiDX standards, or any other Internet protocol software and standards, including mobile commerce technology.

It is still another object of the present invention to facilitate an orderly and readily available market for the sale of chemical products through a systematized process that maintains a current price listing at which the products are being sold.

It is still another object of the present invention to offer translation, into one or more languages, of certain sections and items on the web sites to facilitate ease of doing business between customers and suppliers.

It is still another object of the present invention to offer the facility of a promotion (“promo”) code which is an alpha-numeric code entered into a field on a web page which can cause the net price to be adjusted. The promo code can be product, customer, region, or time-frame dependent.

It is still another object of the present invention to offer basic services, such as the capability to communicate via the web site (“contact us”), news items, Material Data Safety Sheets (“MSDS”), sales specifications, product details, a media page, manufacturer details, site demonstration, site navigation tools plus other sections helpful to customers and suppliers. In addition, these services can be offered in one or more languages.

It is still another object of the present invention to offer business rules and legal terms and conditions on the site that are global in nature to facilitate the ease of understanding of the business method. In addition, these business rules and legal terms and conditions can be in offered one or more languages.

It is still another object of the present invention to differentiate the business rules and method of doing business on the web pages or sites, such that transactions, offers and business through the site causes minimal conflict with other channels operating with their respective business rules, such as the manufacturer's direct business and/or the manufacturer's distributors/agents.

### SUMMARY OF THE INVENTION

The present invention is a portal system or a web-based distribution system which incorporates existing contractual obligations and automates how to fulfill and track the contractual obligations; and electronically tracks and fulfills purchase orders having specific business rules of contracts.

The present invention is a differentiated channel to market, using the Internet and a web site, to operate a new, global business rule structure. The present invention is different from existing “channels to market”; and does not compete with, but complements, existing channels to market by preserving the offering of other direct and distribution channels.

Accordingly, one aspect of the present invention is directed to an Internet-based, web-based computerized method of buying and selling a commodity-type product useful in manufacturing and processing industries including the steps of:

(1) providing a web site system offering products that includes a browsable catalog of the products and provides services for allowing customers to electronically choose and purchase the products at a pre-established price and on a self-service basis;

(2) requiring the customer to agree to an initial purchase agreement for said products, said purchase agreement containing a first set of pre-established terms and conditions and a second set of surcharge-bearing terms and conditions which are activated and implemented upon the purchaser requesting modification of the first set of terms and conditions after the initial purchase order is submitted electronically by the customer and accepted by the manufacturer of said products;

(3) transacting a sale of the product and/or other products of the catalog with the customer through the web site system; and

(4) completing the transaction by fulfilling the purchase order based on the initial purchase agreement or any modification thereof.

Another aspect of the present invention is directed to an Internet-based, web-based computerized sales system to allow an Internet user to purchase a commodity-type product useful in manufacturing and processing industries including:

(1) a web site system offering products that includes a browsable catalog of the products and provides services for allowing customers to electronically choose and purchase the products on a self-service basis;

(2) an initial purchase agreement for said products, said purchase agreement required to be agreed to by the customer, said purchase agreement containing a first set of pre-established terms and conditions and a second set of surcharge-bearing terms and conditions which are activated and implemented upon the purchaser requesting modification of the first set of terms and conditions after the initial purchase order is submitted electronically by the customer and accepted by the manufacturer of said products;

(3) means for transacting a sale of the product and/or other products of the catalog with the customer through the web site system; and

(4) means for completing the transaction and fulfilling the purchase order based on the initial purchase agreement or any modification thereof.

The portal system and method of the present invention has several advantages over prior systems including, for example being the only site with chemical products on a home page which are sold under strict business rules. The products are available in a number of geographies, with the business rules and terms in English and translations in several languages deriving from the English version. A browser-based three-step order process is used with customer information stored on site. An on-line customer registration process is used with authorization completed, for example, within 48 hours.

The advantages of the present invention over prior systems include for example, ease of use, speed of data and news transfer, customer self-service, electronic confirmations, transparency, lack of conflict with other direct and distribution channels, and a lower cost to operate.

The portal business of the present invention is an all electronic communication system; and therefore, provides paperless transactions. The transaction includes the sale of fixed quantities of high volume, low TS&D products; one payment term, with the option of paying in one of at least two or more currencies. The portal business of the present invention creates a highly convenient, low-cost, one-stop shopping web site. The web site may include products from a manufacturer and other producers of other chemicals that complement the manufacturer's various products, and the standard equipment used in a customer's business. The present system provides a means for renting “storefronts” to regional and/or specialty producers. The present system has the capability of launching on-line auctions and providing special deals. The present system has flexibility to increase product offering but without competing with existing channels to market. The present system offers products at a competitive price. The system starts with a minimum product offering and has the flexibility to be extended to other products and geographies at any time in the future.

### BRIEF DESCRIPTION OF THE DRAWINGS

A more complete understanding of the present invention, as well as further features and advantages of the present invention, will be obtained by reference to the following detailed description of preferred embodiments of the present invention taken in conjunction with the accompanying drawings, in which like reference numbers and designations refer to like elements throughout the several views.

FIG. 1 is a diagram of a conceptual representation of the Internet operation.

FIG. 2 is an overview diagram illustrating one preferred embodiment of the purchasing system of the present invention including generally the logic processing for dealing with a user at the web site and describing the preferred method of the transaction of the present invention.

FIG. 3 is a flow chart showing the steps in general for placing an order in accordance with one embodiment of the present invention.

FIGS. 4A-4D is a series of computer screens showing product information accessible to a user in accordance with one embodiment of the present invention.

FIGS. 5A-5F is a series of computer screens showing registration information to be completed by a user in accordance with one embodiment of the present invention.

FIG. 6 is a computer screen showing account information of a user in accordance with one embodiment of the present invention.

FIG. 7 is a computer screen showing a web page for changing account information by a user in accordance with one embodiment of the present invention.

FIGS. 8A-8D is a series of computer screens showing a product ordering process by a user in accordance with one embodiment of the present invention. FIG. 8A also shows an example of the operation of a promo code to effect a change in purchase price of a product(s) on the web site in accordance with one embodiment of the present invention.

FIG. 9 is a computer screen showing a web page for a user to access business rules and legal terms of the web site in accordance with one embodiment of the present invention.

FIG. 10 is a web page obtained from the web site of the present invention showing an example of the differentiated business rules of the web site in accordance with one embodiment of the present invention. These business rules are shown in English, but may be translated into, for example, an additional eight other languages.

FIG. 11 is a web page obtained from the web site of the present invention showing an example of the differentiated legal terms and conditions of the web site in accordance with one embodiment of the present invention. These legal terms and conditions are shown in English, but may be translated into, for example, an additional eight other different languages.

FIG. 12 is a computer screen showing an initial introduction web page accessible to a user on the web site in accordance with one embodiment of the present invention.

FIG. 13 is a computer screen showing a tour web page on the web site in accordance with one embodiment of the present invention.

FIG. 14 is a computer screen showing a web page for a user to communicate with a supplier in accordance with one embodiment of the present invention.

FIG. 15 is a computer screen showing a web page for a user to access frequently asked questions (FAQ) in accordance with one embodiment of the present invention.

FIG. 16 is a computer screen showing an informational web page of a supplier on the web site in accordance with one embodiment of the present invention.

FIG. 17 is a computer screen showing a material safety data sheet (MSDS) web page for a product on the web site in accordance with one embodiment of the present invention.

FIG. 18 is a computer screen showing a media information web page on the web site in accordance with one embodiment of the present invention.

### DETAILED DESCRIPTION OF THE PREFERRED EMBODIMENTS

The present invention is directed to a business system and method related to executing a new channel strategy for a niche market using a portal system i.e. a niche portal, herein referred to as a “portiche”, operating on differentiated business rules in the chemical, plastic and process industries, and utilizing the Internet and web sites, to market and sell products globally.

The portiche of the present invention provides a computer system and a method of operation thereof that allows buyers, manufacturers and distributors of goods to conveniently participate in the e-commerce marketplace with minimal disruption to existing direct and distribution channels. This is accomplished by providing a globally available, web-based system wherein prospective buyers of goods and services can communicate a binding order or orders for goods and then allocating such order(s) to manufacturers, distributors and retailers according to distribution channel protocols defined by the manufacturers and operator of the channel. This ensures that sales of brand goods and services via the Internet reduces the risk of violating existing direct and distribution agreements between the manufacturers and their respective distributors and retailers, once the differentiated business rules are fully explained.

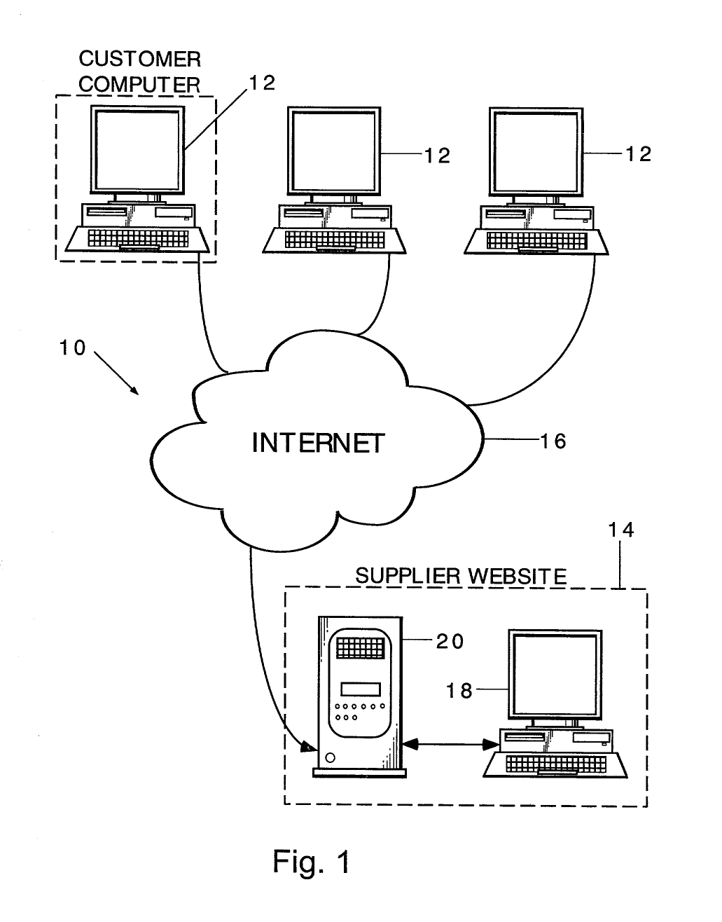

Referring now to FIG. 1 there is shown an overview of one embodiment of the purchase order system 10 of the present invention. With system 10 a host of users shown as 12, access a web site 14 of a supplier of products using the Internet 16. Each of the users 12 has a computer terminal with the appropriate software for accessing the Internet. Although the users 12 are unknown to the supplier's computer 18 and web server 20, the process allows each user 12 to browse the supplier's web site and explore how the supplier's purchase order system functions in an unsecured portion of the web site 14. The user 12 can register as a purchaser on the supplier's web site 14 and then purchase products in a secure portion of the web site once the user is approved by the supplier.

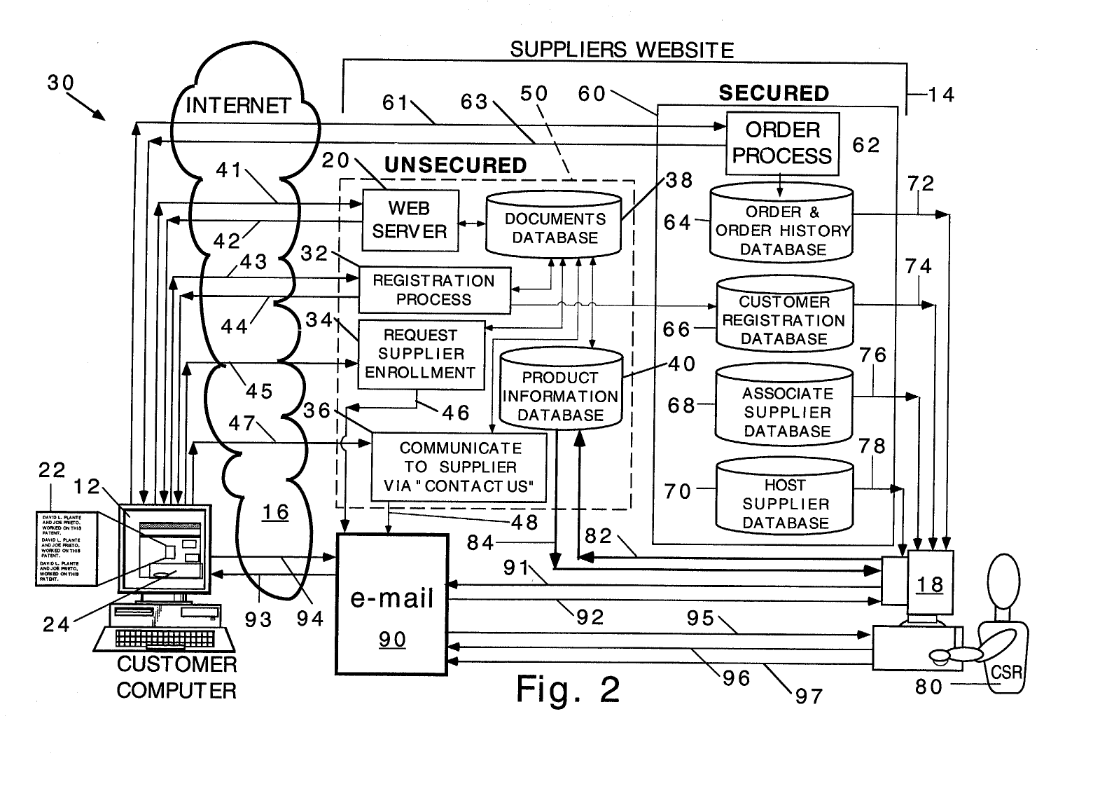

With reference to FIG. 2, there is shown an overview or general architecture of one embodiment of the system and process of the present invention purchase order system, generally indicated by numeral 30, including a customer computer 12 with a capability of retrieving web document 22 from the supplier's web site 14 through the Internet 16 with a web browser 24 and cookie (not shown). The supplier's web site 14 may contain several data bases, for example, documents database 38 and product information database 40 and necessary computer program(s) to provide the user the necessary or desired documents. The host supplier web site 14 contains an unsecured portion 50 and a secured portion 60.

Using the system of the present invention as shown in FIG. 2, the user (prospective customer) on the user's computer 12 may optionally perform any of the following: (1) browse the web site via the web server at 20, (2) register as a prospective customer at 32, (3) request from the host supplier to enroll as an associate supplier at 34, (4) communicate with the supplier of the host web site via a web page screen referred to as “contact us” at 36, or (5) order product(s) from the catalog on the web site at 62. As shown in FIG. 2, the processes 20, 32, 34 and 36 can be carried out by a registered or unregistered user in an unsecured environment represented by a dotted line box 50. In other words, in box 50, the information and shared documents on the web site are open to the public via the Internet.

The ordering process 62 can only be carried out by a registered user in a secured environment represented by solid box 60. Access to the ordering process by a user is illustrated by communication flow lines 61 and 63 in FIG. 2. In other words, in box 60, the information and stored documents on the web site are only accessible to a registered customer and accessibility is password protected. The order entries are stored in order entry data base 64.

Once a user becomes a registered customer by executing the registration process 32, the customer's registration information is stored in the customer registration data base 66 in secured environment 60. Such information, personal to the particular customer, is only accessible by the particular customer and the host supplier.

Once a user enrolls as an associate supplier by requesting the enrollment at 34, the associate supplier's information is stored in the associate supplier data base 68 in secured environment 60. Such information, personal to the particular associate supplier, is only accessible by the associate supplier and the host supplier.

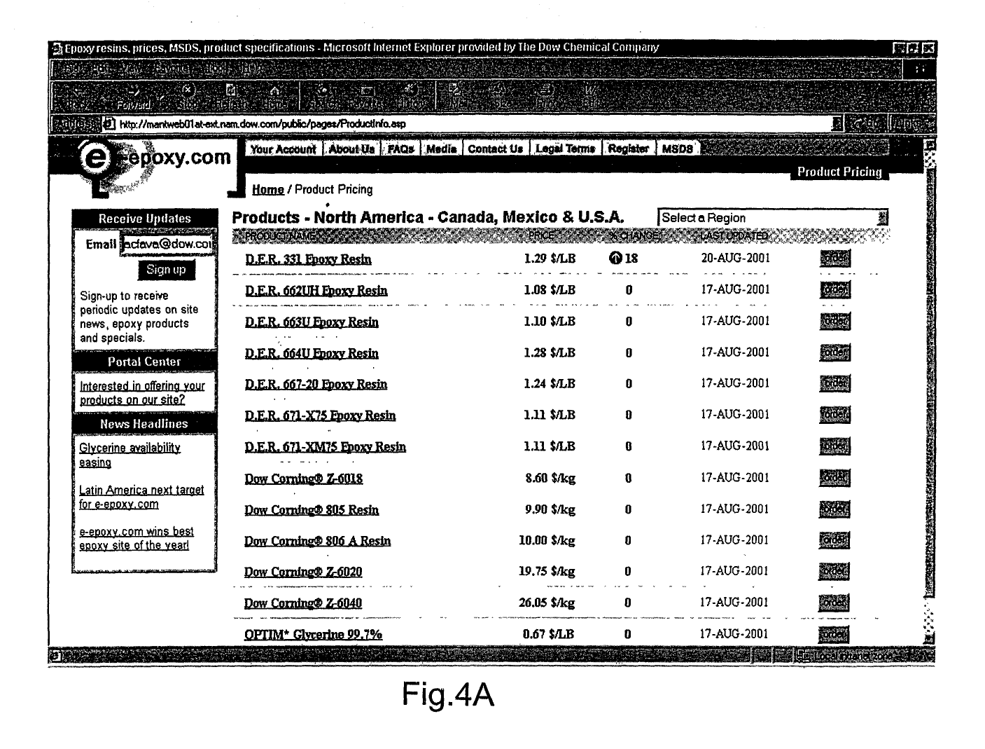

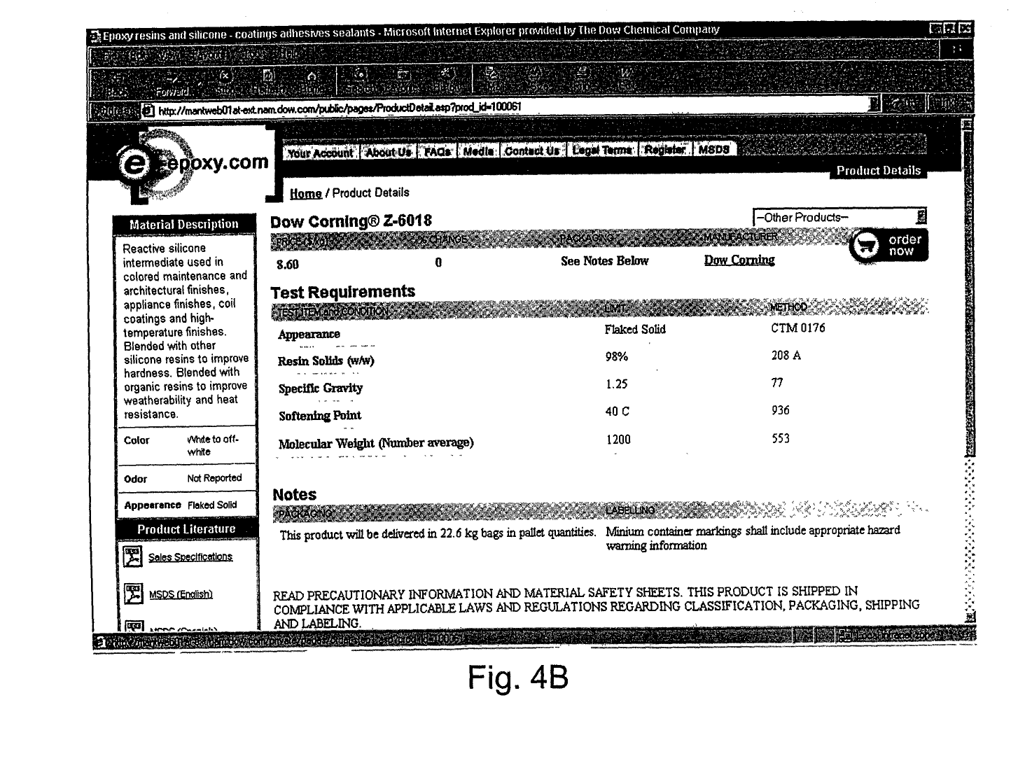

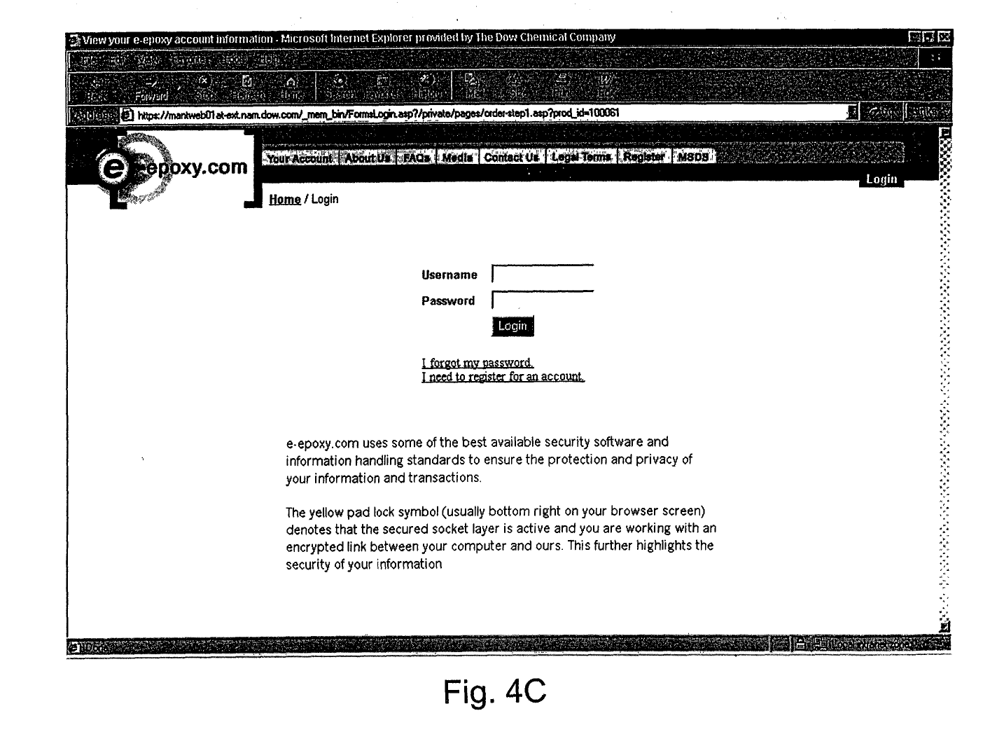

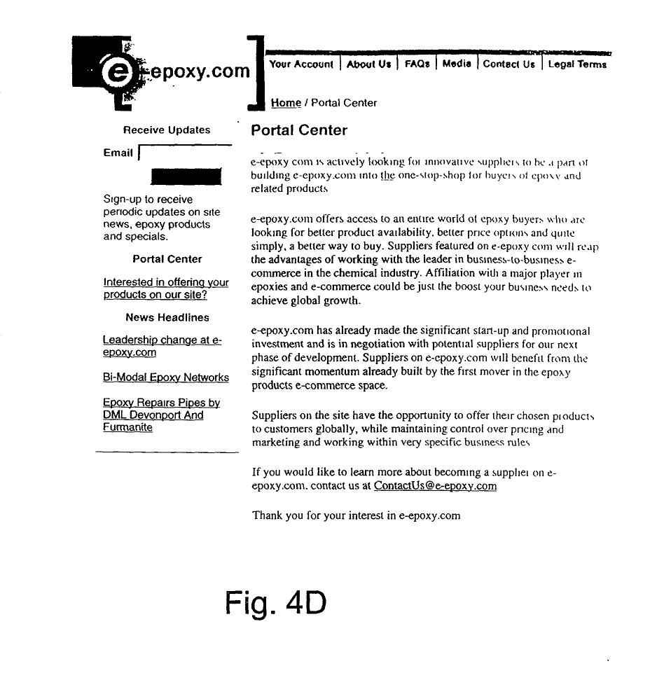

As aforementioned, in the non-secured area, the user may browse through several web documents 22 by requesting and retrieving HTML documents 22 from the web server 20 and document storage database 38 and viewing the documents via the web browser 24. For example, the documents include product description and information from product information data base 40 as illustrated in the web pages shown in FIGS. 4A-4D, 5A-5F and 8A-8D. This communication flow via the Internet using an HTTP protocol is shown by communication flow lines 41 and 42.

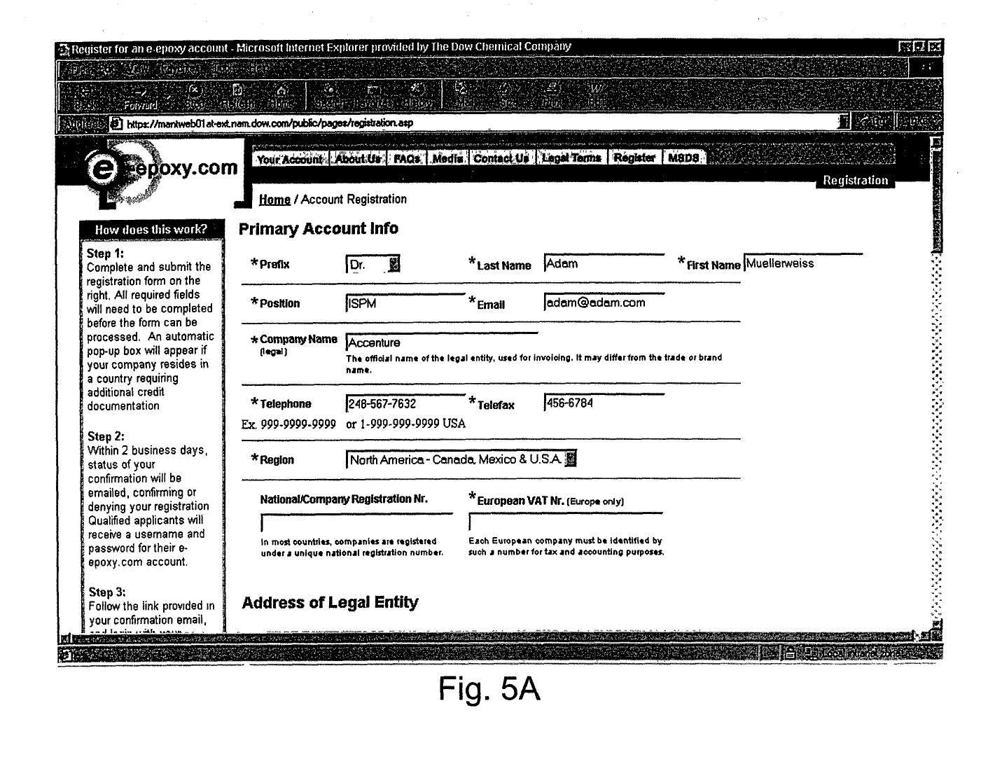

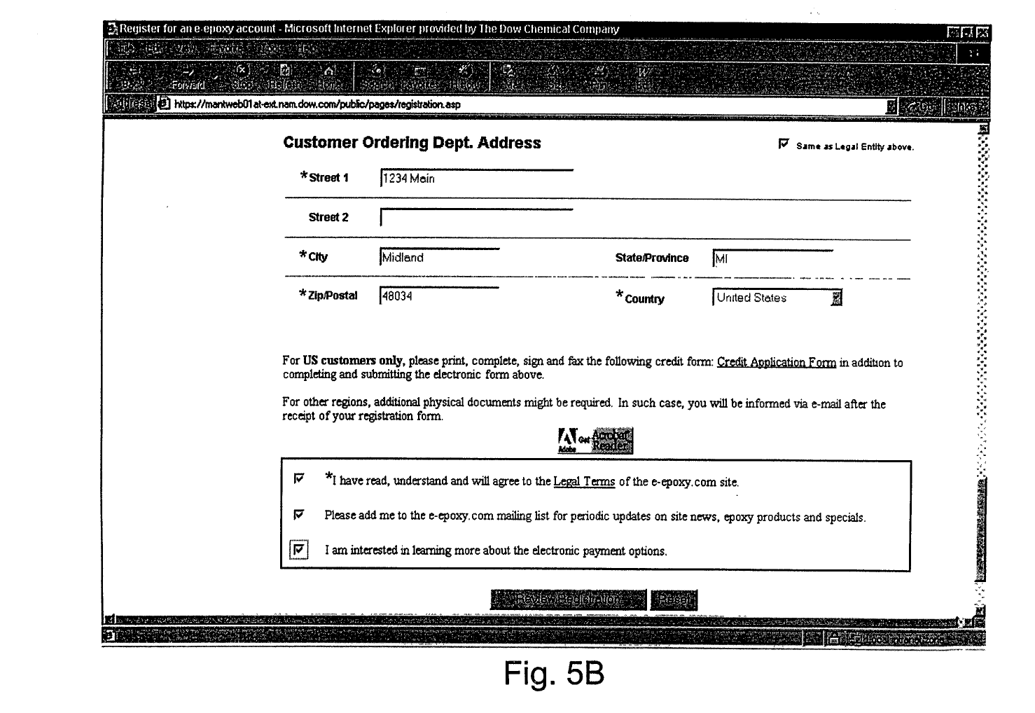

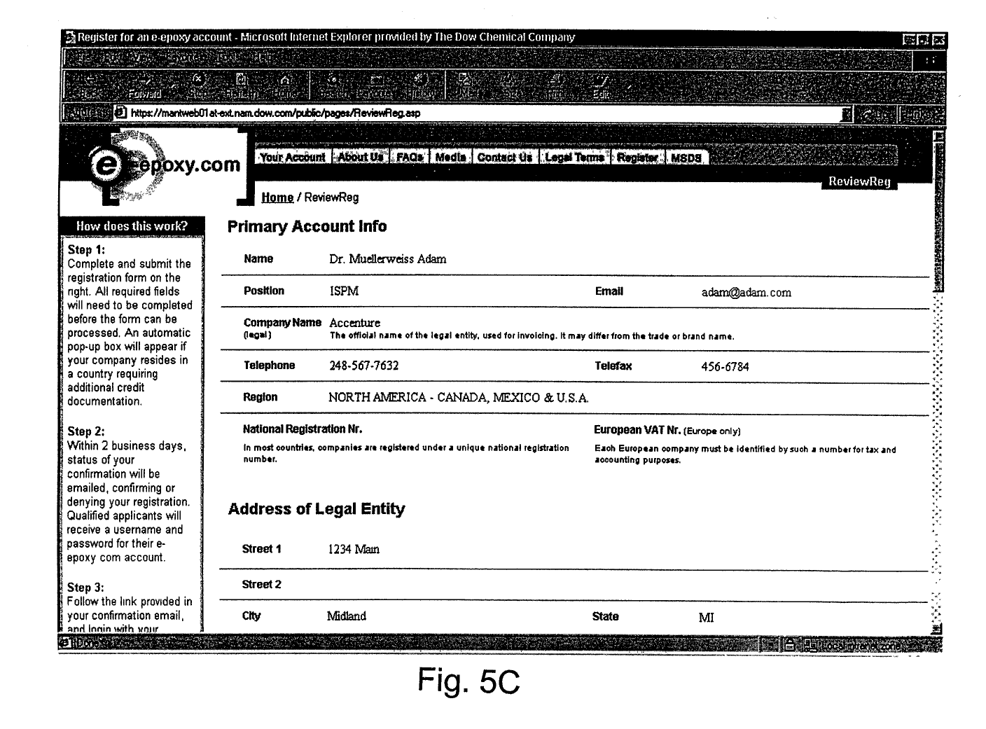

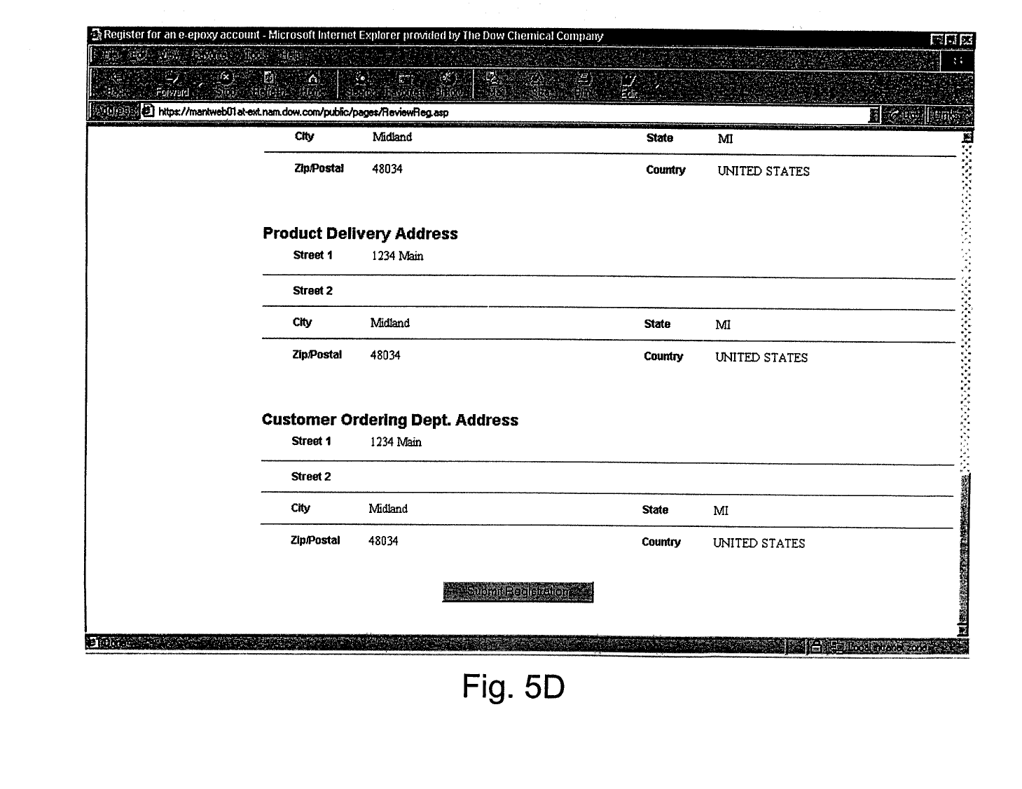

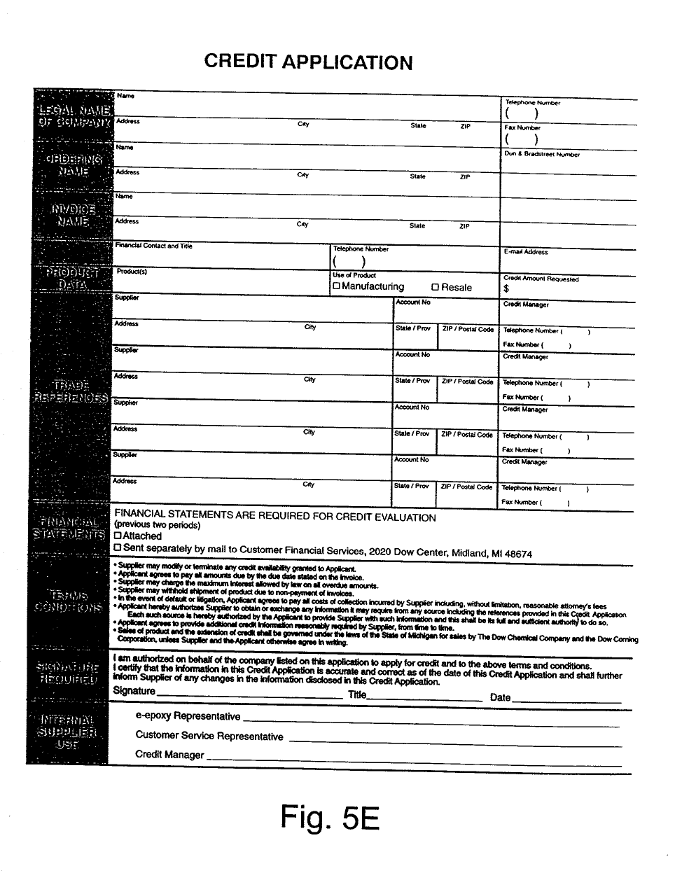

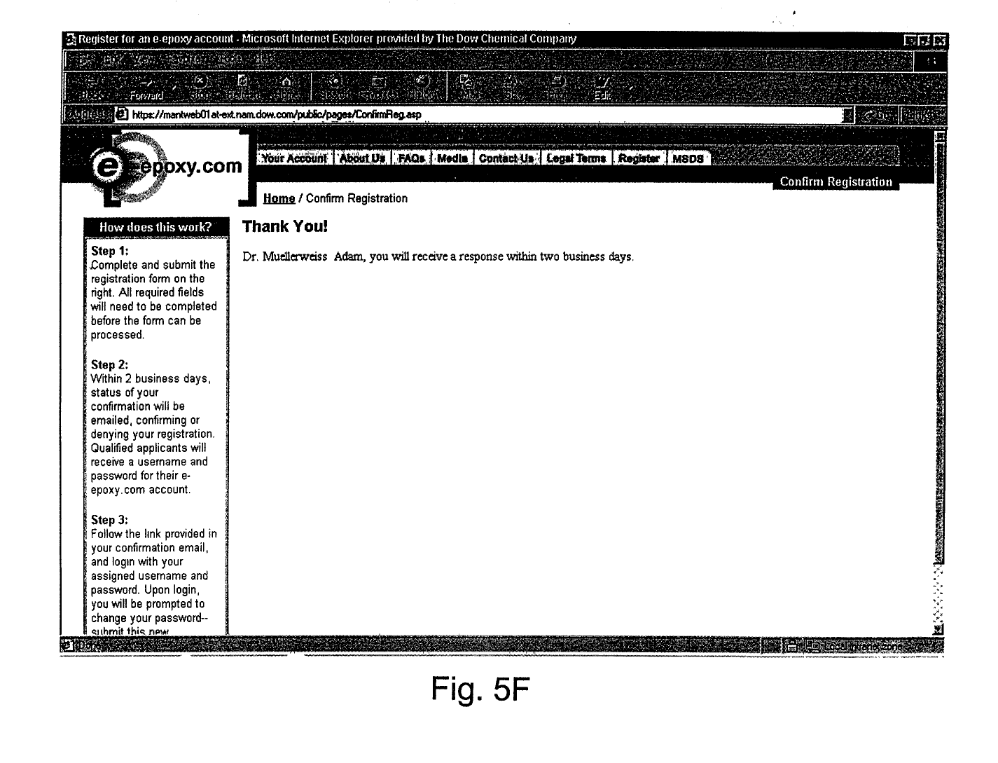

The user can also register through the registration process 32 which is described in more detail below with reference to FIGS. 5A-5F. The user retrieves and completes registration documents as shown in communication flow line 43 and once registration is submitted, the user automatically receives an e-mail acknowledgement generated from supplier's web site as indicated by communication flow line 44 upon completing and submitting the user's registration form to supplier.

In the non-secured area, the user can also request to enroll as an associate supplier by communicating with the host supplier at 34 via a hyperlink accessed by user indicated by communication flow line 45 and the web site automatically generates an e-mail acknowledgement as shown by communication flow line 46. The host supplier is contacted by the user through the portal center shown in FIG. 5D and then communication by e-mail via an external e-mail supplier at 90 is sent to the host supplier. In another embodiment, although not shown, the associate supplier enrollment process may be automated via the web site similar to the registration process 32.

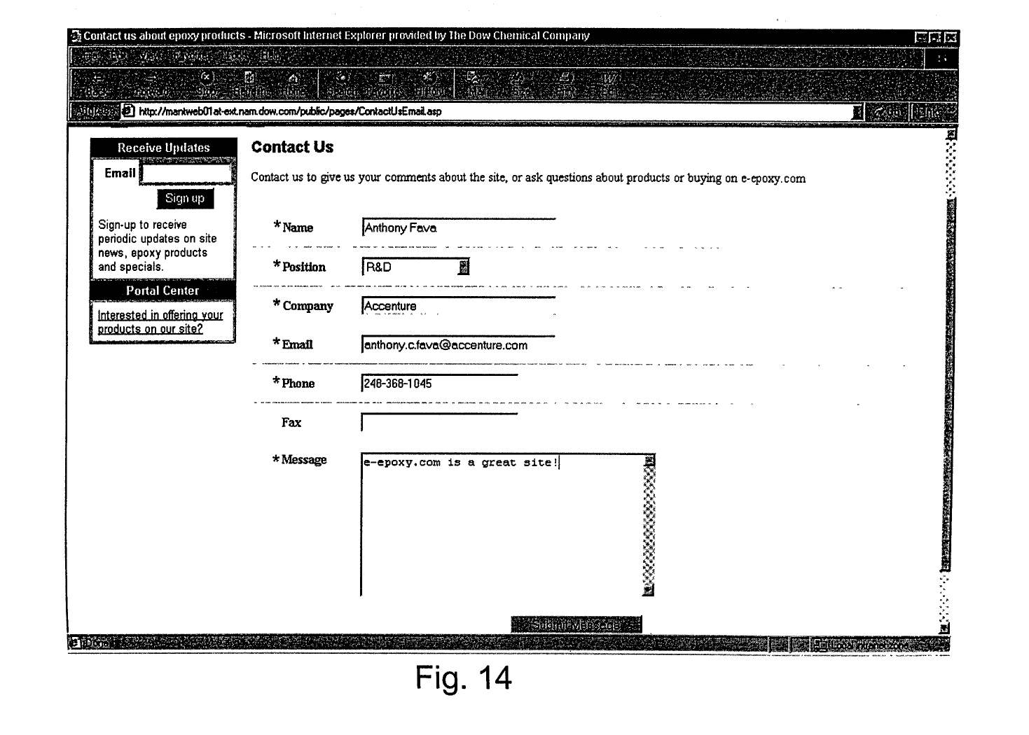

The user also has the option to communicate with supplier via the web site at 36 using the “contact us” web page (see FIG. 14) accessed by user as shown by communication flow line 47 and the web site generating an e-mail response as shown by communication flow line 48. Any e-mail from the “contact us” web page at 36 or enrollment request at 34 is forwarded to supplier via an external e-mail provider 90. In this embodiment, the e-mail is routed to supplier as shown by communication flow line 91 which is answered by supplier by return e-mail communication flow line 92 to the user. However, the user has the option at any time to send e-mail directly to supplier as shown by communication flow line 93 via the external e-mail provider 90 and also to receive e-mail from supplier as indicated by communication flow line 94 via the external e-mail provider 90.

Some of the other e-mail communications received by the customer/user from the supplier is a registration notification approval as shown by communication flow line 95 after a customer service representative (“CSR”) 80 receives the user's registration form retrieved from the data base at 66 and the registration is approved. The customer also can receive an order notification via e-mail as indicated by communication flow line 96 after CSR 80 processes the customer's order retrieved from the data base 64 and the order is approved. Yet another notification to a prospective associate supplier may be made by an e-mail, indicated by communication flow line 97 from supplier notifying user of acceptance of enrollment as an associate supplier after CSR 80 processes an enrollment form received from the associated supplier and enrollment is approved.

Another function of the CSR 80 is to maintain the information on the web site current by updating files on product pricing at database 40 such as the pricing information on the product pricing web page shown in FIG. 4A. This updating operation is shown by communication flow lines 82 and 84.

While the embodiment shown in FIG. 2 includes a CSR 80, it is understood that the CSR may be alternatively replaced via integration of the portiche to the supplier's ERP systems. The integration would automate the manual transactions and reduce the cost to serve.

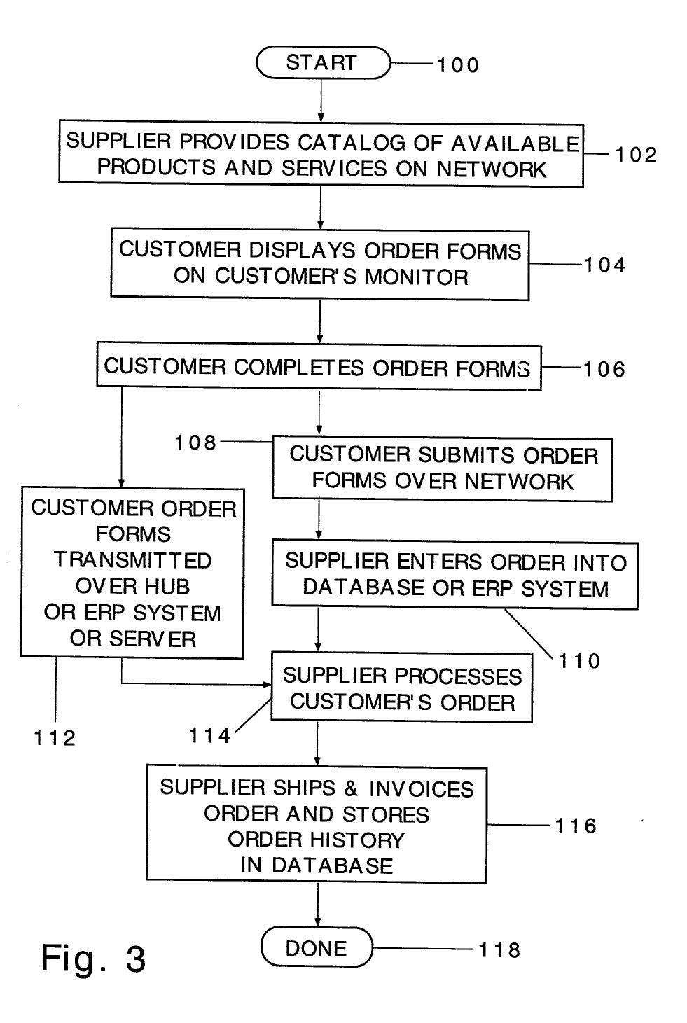

With reference to FIG. 3, there is shown a flow chart of one embodiment of the overall process for purchasing a product by a registered customer. For example, the customer starts at 100 by accessing supplier's web site on the network. A catalog 102 is provided on the network with the available products and services of the supplier. An order form 104 is displayed on the customer's monitor. The customer completes the order form on the network at 106. Then the order form is transmitted over the network at 108. Once the supplier receives the customer's order form, it is entered into the customer data base at 110. In another embodiment, a customer's order form can be entered automatically using, for example, an ERP system as shown at 112. The customer's order form is processed at 114 and then the order is finalized and stored in the data base at 116. The transaction is then completed as shown in 118.

Generally, the Internet portal system and method i.e. the portiche, of the present invention involves electronic commerce and is an electronic marketplace designed for online trading using a web trading site which can be used to buy and sell any product in the chemical, plastic and process industries. As one illustration only, the present system and method is described with reference to selling and purchasing epoxy resin products and epoxy-related products. Accordingly, the preferred embodiments of the present invention will be directed hereinafter to commodity type products such as epoxy resins; and the web site illustrating one specific embodiment of the present invention will be referred to herein as “e-epoxy.com”. However, it is understood by those skilled in the art that other high-volume “standard” products, similar to epoxy resins and epoxy-related products, can be bought and sold using the present invention.

The e-epoxy.com system is a portiche e-commerce site that makes purchasing epoxy resins and epoxy-related products as easy and cost effective as possible for customers. The present invention is a low transaction cost channel to market, controlled by a business targeting small to medium sized customers. The preset system is easy to use, efficient, and economical for a user or customer or prospective purchaser. The e-epoxy.com site of the present invention is set up as a low-cost procurement channel of epoxy materials, and is not intended to compete with other e-commerce initiatives in which the manufacturer company or its agents/distributors are involved. The web site of the present invention is for customers looking for a fast, no-frills way to spot buy epoxy resins. The web site of the present invention is not intended for those customers looking for a higher level of support from the supplier and one-on-one contact between customer and supplier. The system is preferably used to compete on price in the spot market against foreign importers or low-priced, no-frills sellers i.e., the system and method of the present invention is a selective play against importers or the low-priced segment of the marketplace. The system does not need all the frills or need to put up with generally longer lead times from importers.

The present system allows a customer to buy from a supplier without the hassle of negotiating price, terms, and quantities. The customer has to agree to surcharges, for example, $750 every time the customer changes the delivery date and $800 every time the customer is late with a payment. The present system works because eliminating extra work, choice and paperwork allows a supplier to cut costs and prices.

### ACCESS OF PRODUCT INFORMATION BY A USER/CUSTOMER

The portiche web site of the present invention has the capability to store and to offer visitors to the web site, i.e. prospective customers, views of a host portal supplier's and other associate portal supplier's products and information related to such products. One of the advantages of the electronic service system and the web site of the present invention is to save users time by enabling easy access to receiving documentation and product information needed by the customer, including, for example, regularly updated market pricing for the products, product specifications, technical data sheets, Material Safety Data Sheets (MSDSS) and news items related to the products or the web site.

With reference to FIGS. 4A-4D, there is shown a series of computer web page screens showing one embodiment of information accessible by a prospective customer. Screen FIG. 4A referred to herein as the “Product Pricing” page is also, for example, the default “Home” page for the web site. The Product Pricing page can be accessed by both registered and non-registered users. The Product Pricing page, screen FIG. 4A, on the web site is a catalog or list of all the products along with each of the products' prices available in a particular selected region. Referring back to screen FIG. 4A, the graphical layout of the Product Pricing page, which includes, for example, the list of displayed products and product prices, may show various products and prices which may be different depending upon the region selected. The products may be sorted by products alphabetically, by producer alphabetically or in any other order desired. The regions are selectable, for example, from a “Select a Region” drop down list box located on the Product Pricing page. The user can select a particular region to view by selecting the region from the drop down list box. The regions include for example the following: “North America—Canada, Mexico & U.S.A.”; “Europe-Western & Central”; “Middle East & Turkey”; “Brazil”; “Chile, Argentina, Paraguay, Uruguay”; “Latin America—North”; “Japan”; SE Asia & Taiwan”; “South Korea”; and “Others”. The region shown in FIG. 4A is “North America—Canada, Mexico & U.S.A.” Detailed information about the products listed on the Product Pricing page can optionally be viewed by the user by clicking on a link associated with each product name which takes the user to a “Product Details” page, for example as shown in screen FIG. 4B.

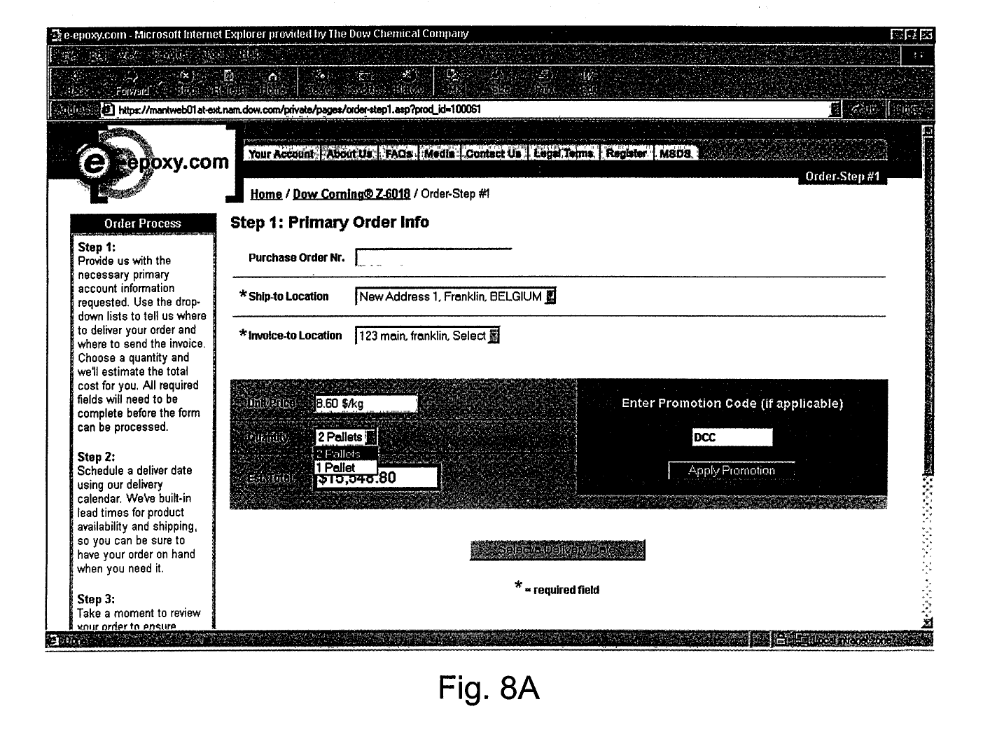

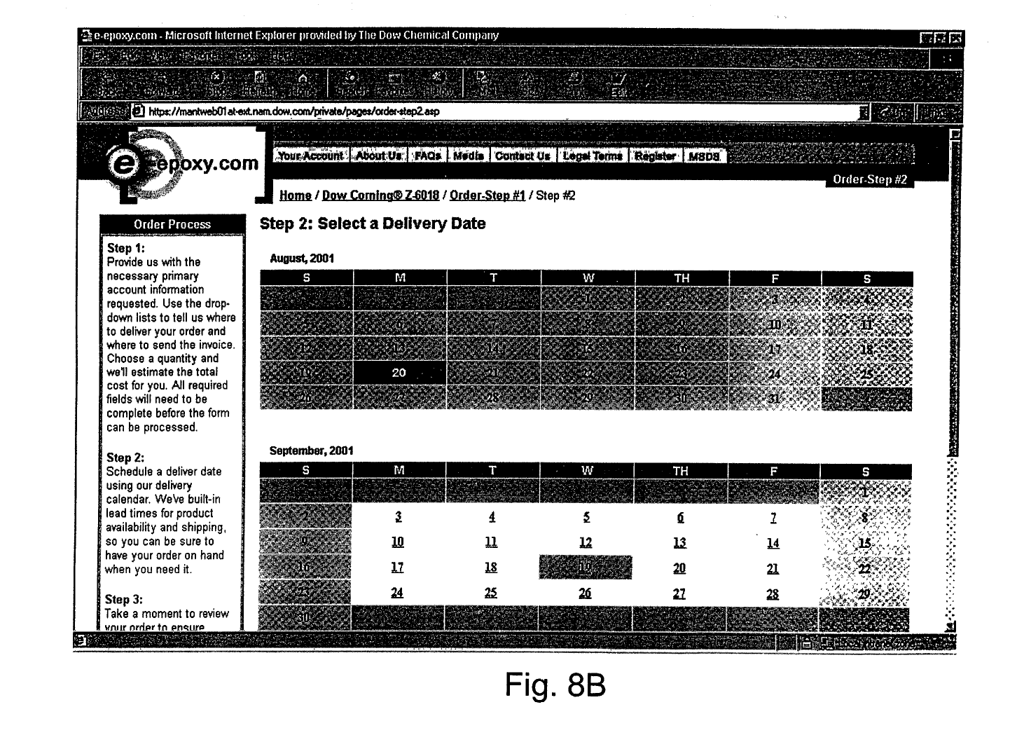

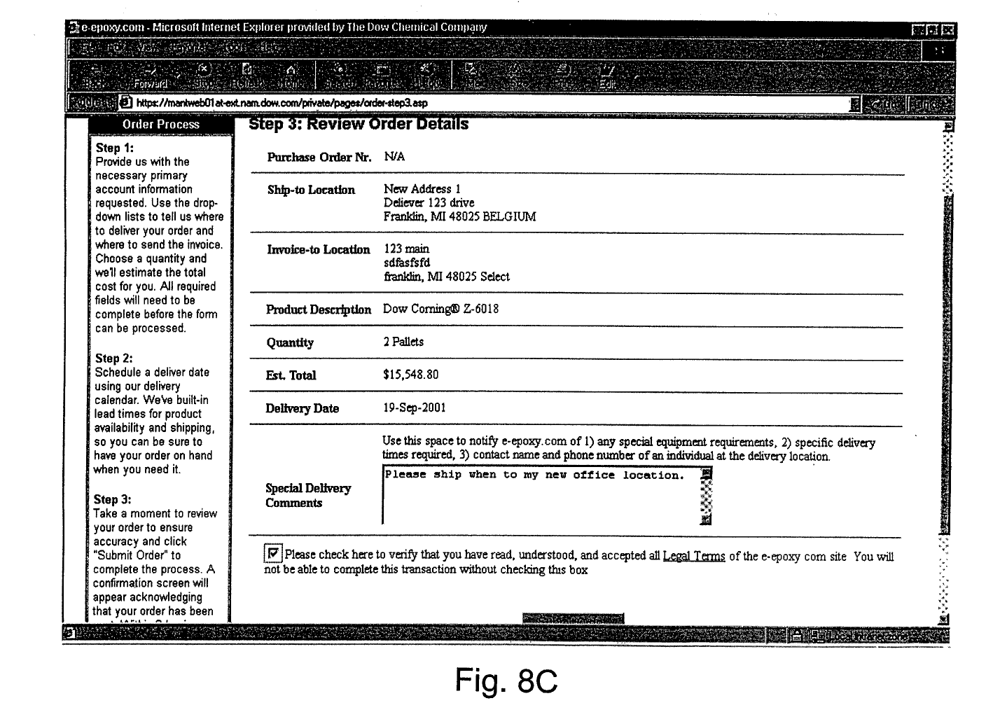

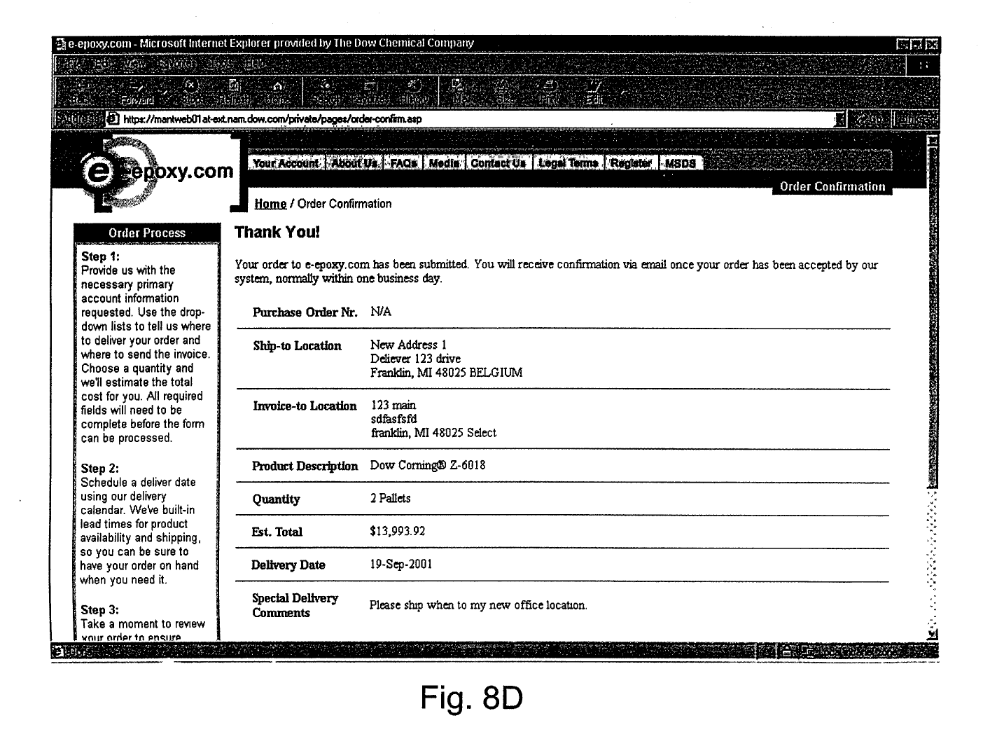

Also preferably located on the Product Pricing page is an “order” button. The screens for placing an order (See FIGS. 8A-8D below), can be invoked by clicking on the button labeled “Order” next to each product name on the list of products shown in screen FIG. 4A. However, the user would have to be a registered user and logged in to have the option to place an order. If the user is not a registered user, then the user will be taken to a login page, screen FIG. 4C, where the user can login if the user is registered or where the user can register using the registration link if the user is not registered. For example, by clicking on the link “I need to register for an account” as shown in the login page FIG. 4C, the user is taken to an “Account Registration” page of the web site (see FIGS. 5A-5F) to allow the user to register.

A sidebar located on the Product Pricing web page, FIG. 4A, includes, for example, the following items: an “e-mail” box, a “Portal Center” link and a “News Headlines” link.

A user can sign up for periodic updates by entering the user's email address in the “e-mail” box.

The “Portal Center” link is a link to a “Portal Center” page for example as shown in FIG. 4D, which allows the user, who may also be a supplier of products, to find out how to enroll as an associate supplier on the web site to sell its products.

The “News Headlines” link lists current headlines related to the products on the web page or related stories. The user can see the details behind any headline by clicking any of the links provided under this item. The headlines are read, for example, from a news table.

Other links can be optionally installed on the Product Pricing page's side bar as desired by the host portal supplier. Customers, such as processors, who purchase materials using the portiche system and method of the present invention will realize many benefits, including access to a wealth of technical information and processing guidance, plus extensive product-design assistance.

### PROCESS FOR CUSTOMER REGISTRATION

Before a user can order a product on the Product Pricing web page, FIG. 4A, the user should preferably first be registered. Registration is an important part of the process of customer acceptance due to the necessary commercial, credit and health and safety checks to be performed. One preferred process for user registration will be described herein below with reference to FIGS. 5A-5E, however the present invention should not be limited to this specific embodiment. With reference to FIGS. 5A-5E, there is shown a registration data entry screen, FIGS. 5A and 5B, on the web site referred to as the “Account Registration” page that allows the prospective customer/purchaser to enroll in the purchasing program. FIGS. 5A and 5B show an example of the registration page, where customers can give enough details to register for an account. The registration screens, FIGS. 5A and 5B, allows users to enter in their registration information such as for example primary contact information and details, legal entity address, financial contacts, bank information, invoicing addresses, product delivery address, customer department address and request a credit limit. The process to effect registration includes a commercial check, an environmental, health & safety (EH&S) check and a credit check.

Some of the features of the Account Registration page may include for example:

(1) All mandatory fields are highlighted with an asterisk and are validated for required data;

(2) The user may enter multiple addresses such as for example an Invoicing address and a Product Delivery address;

(3) The user may check a box to indicate that an Invoicing or Product Delivery or Customer Department address is the same as that of the Legal Entity;

(4) If a user is in Western Europe a space for the required European Vat Number may be provided;

(5) If a user's bank is in a particular country such as Germany a space for the required bank code may be provided; and

(6) There may also be a link to a credit application form that U.S. customers are required to complete.

In the preferred embodiment of the present invention, the users must acknowledge their acceptance of the legal terms and conditions by clicking an “acceptance” box on the Account Registration page; and a similar box must be clicked before placing every order, during the final stage of order submission.

A side bar located on the Account Registration page describes generally the three-step process of registration which includes for example:

(1) completing and submitting the registration form screen FIGS. 5A and 5B after reviewing information screen FIGS. 5C and 5D;

(2) confirming or denying registration notification; and

(3) changing password to confirm registration.

After entering the registration information, the prospective customer may review the registration information in a review screen, FIGS. 5C and 5D, which is similar to the Registration data entry screens FIGS. 5A and 5B. The user may make modifications to the user's information entered on the web page before the user completes the transaction. After the customer reviews the registration information and is satisfied that the information is complete and correct, the customer may submit the registration information from the review screen on the web page by clicking the “submit” button on the web page. U.S. users will be prompted to check if they have completed a Credit Application form, for example, as shown in FIG. 5E. The registration information is then recorded and stored in a registration database located at the site of the host server (computer). The customer receives an e-mail confirmation message, FIG. 5F, on the user's screen that the supplier has received the user's registration information. An email with a customer ID number is also sent to the supplier's registration database where it is retrieved by a supplier's CSR who follows up with approving the user.

Preferably, the registration screen of the present system is valid worldwide, and once completed electronically and submitted (including all necessary paper documents/copies), sets off a credit, EH&S and commercial approval mechanism aimed at delivering a registration approval and credit exposure limit to the user within 48 hours (2 working days). Qualified applicants will receive a username and password for their e-epoxy.com account.

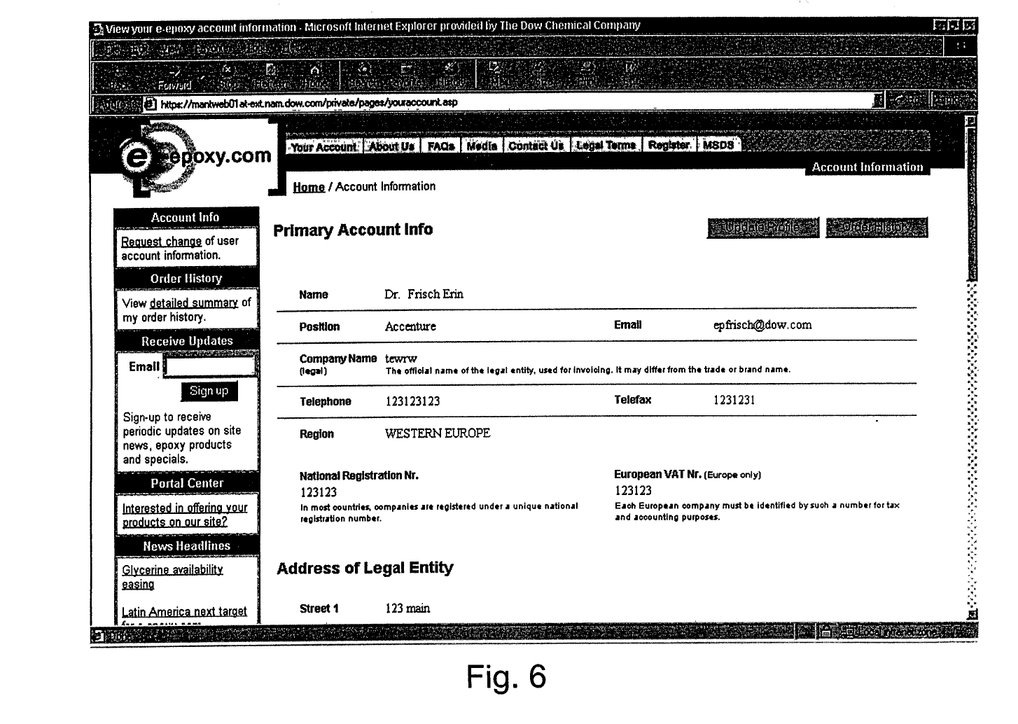

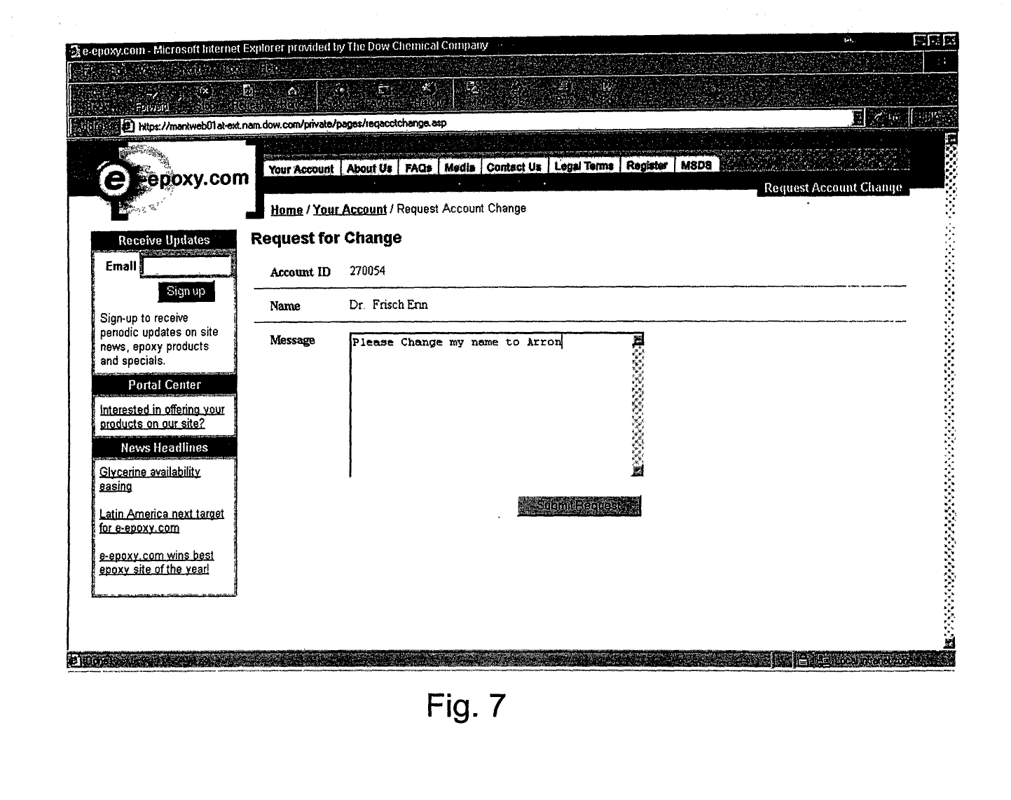

At any time after registration, customers may access their account, for example, as shown in web page screen FIG. 6. Also, the customers may update their profile information, for example, as shown in web page screen FIG. 7.

### PROCESS FOR ORDERING PRODUCTS BY A CUSTOMER

The portiche system and method of the present invention provides a web site that is designed to facilitate business-to-business e-commerce transactions. One preferred process for ordering products from the present invention web site will be described with reference to FIGS. 8A-8D, however the present invention should not be limited to this specific embodiment. With reference to FIGS. 8A-8D, there is shown a series of screens illustrating the ordering process of products by a registered customer. All customers enter orders on their browser over the web site.

The ordering process by the prospective customer preferably has three general steps including, for example:

(1) entering the order information shown in screen FIG. 8A;

(2) selecting the delivery date as shown in screen FIG. 8B; and

(3) reviewing all the details about the order as shown in screen FIG. 8C.

Preferably, a side bar located on the order pages, screens 8A-8C, generally describes the three-step process of ordering a product(s).

In screen FIG. 8A, the customer fills in the user's primary account information. Using a drop form box, for example, the customer chooses where to deliver product and where to ship invoice. The customer then selects the quantity desired and the computer automatically estimates the price. In this screen, any promotion codes may be entered.

Then, the customer clicks on, for example, a “Select a Delivery Date” button to schedule a delivery date. This button takes customer to screen FIG. 8B.

Preferably, screen FIG. 8B is a delivery calendar with built-in lead times for product availability and shipping. A delivery date may be selected by the customer by clicking on a specific date that is not shaded.

Screen FIG. 8C is a “Review Order Details” page which allows customer to review the order. The customer may enter special instructions for the order in the “Special Delivery Comments” box. The customer then indicates the customer's acceptance of the legal terms by the checking the designated box as shown in screen FIG. 8C. The customer then clicks, for example, a “Submit Order” button which, in turn, submits the order to the supplier.

Once the order is submitted by the customer to the supplier, an email is sent to the customer confirming that the supplier has received the order as shown in screen FIG. 8D. The order status is updated by the supplier on the site for viewing by the customers. The status categories include, for example, (1) confirmation of order receipt request; (2) confirmation of order acceptance; and (3) confirmation of order shipped.

As aforementioned, the Internet-based purchasing system and method of the present invention involves an e-commerce portal system. The present invention described herein is an alternative, competing channel to market. The present system of the present invention is complimentary to other existing Internet-based systems. The value proposition of the present invention is based around easy ordering and purchasing of compatible products, not necessary lowest price. The system and method of the present invention provides a one stop shop to easily buy commodity-type products such as, for example, epoxy and related products at cost competitive prices on an electronic self-service basis.

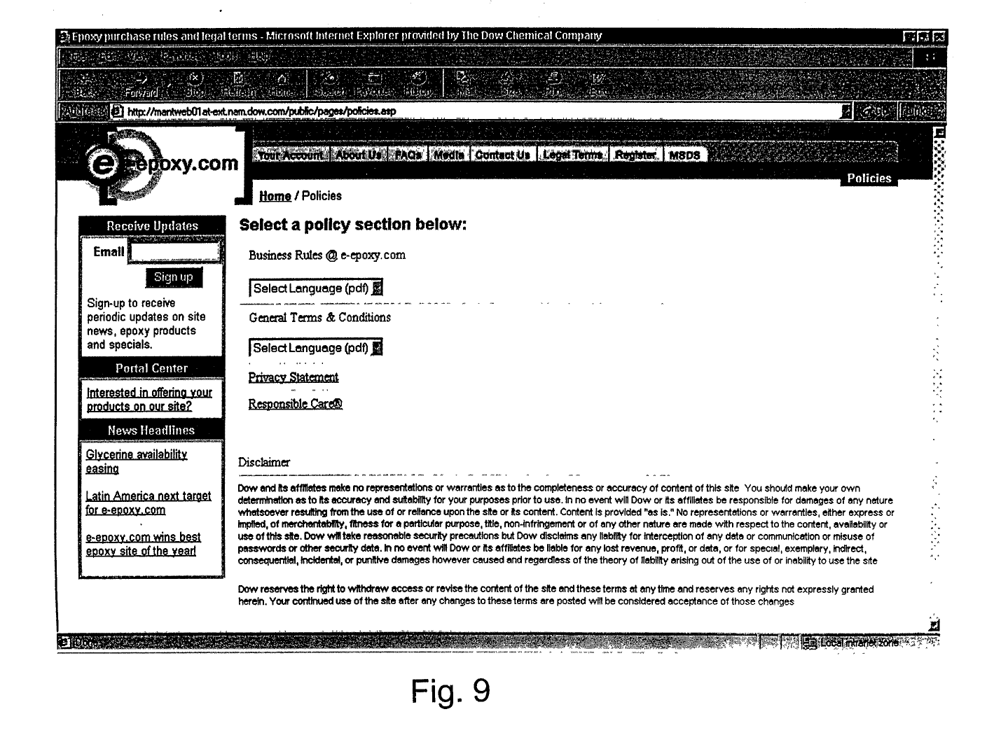

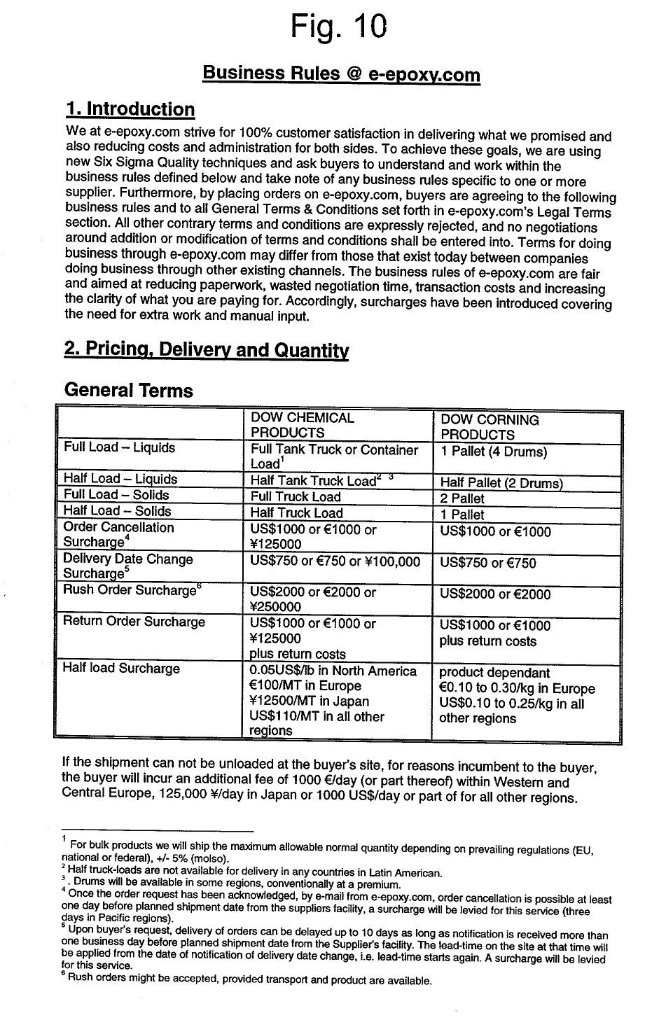

The portiche system and method of the present invention has several distinguishing features which makes the present invention novel and unique. For example, one of the unique features of the system and method of the present invention is the implementation of a set of pre-established straightforward and distinct business practices or business rules. Several of these business rules, either separately or a combination of two or more, have heretofore not been practiced in this industry. The business rules may be reviewed by a user by accessing the rules through a web page screen as shown in FIG. 9. An example of the first page of the business rules themselves is shown in FIG. 10. These business rules and terms and conditions may be translated into several languages including, for example German, Italian, Spanish, French, Portuguese, Korean, Japanese, Chinese (Taiwan). The pre-established business rules for the purchase ordering process of the present invention include for example: (a) electronic trading only, i.e., all transaction are carried out electronically and no paper is involved and no personal or telephone contact is provided for on site, there is only e-mail or use of the “contact us” web page, and the system eliminates the need for customer entertainment, and invoices may be made available electronically; (b) fixed quantities for ordering, i.e. ordering/buying only in “unitized” order sizes such as for example full-, half-, or quarter-truck load quantities wherein a minimum load is required to be purchased (these fixed quantities may be varied by product/manufacturer); (c) conforming to fixed payment terms, i.e. one payment term for the whole world of 30 days net from date of invoice (except regions where longer sea journeys are undertaken, currently some parts of Latin America); (d) penalties and fines for non-payment on-time; (e) penalties for order changes and cancellations; (f) a fixed surcharge for late payment; (g) a fixed surcharge for order cancellation; (h) a fixed surcharge for order date change, (i) a fixed surcharge for “rush” order—within lead-time on site, (j) fixed quantities for ordering, (k) fluctuating price valid for one shipment only, i.e. no contracts, no rebates, no long-term deals, (l) system of 3 order confirmations-confirmation of order receipt, confirmation of order acceptance and confirmation of order shipment, (m) basic technical service, limited to sales specifications and MSDS in 9 languages; (n) news specific to the portiche; (o) no negotiation on business rules or legal terms and conditions, (p) no samples, (q) limited product range, (r) prices available 24 hrs/day on a home page and not hidden, for example, behind a password protected area, (s) special monthly newsletter, and (t) no customer entertainment; (u) no paper rebates offered; (v) pay to get live service; and (w) no long-term contracts. Essentially, customers who wish to use the purchasing system of the present invention will be directed to follow the above specific business practices otherwise any changes after a sale raises the price of the transaction.

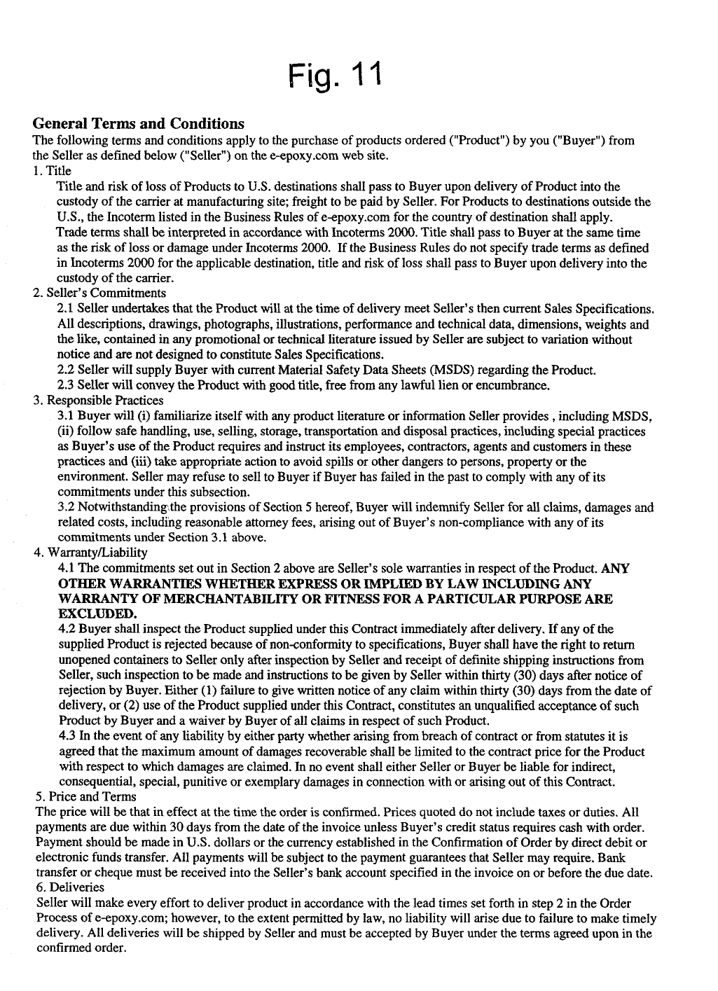

The business rules also include a set of pre-established legal terms and conditions, which can also be accessed through the web page shown in FIG. 9. An example of the first page of the legal terms is shown in FIG. 11. Unlike the application of other legal terms in existence, the business system and method of the present invention has unique legal terms comprising a set of tabular business rules and terms and conditions that are in English, valid, for example, for the geographical operating areas of the site.

Preferably, the system and method of the present invention is a basic self-service, technology service system. Alternatively, however, the system can include a fee-based assisted service.

Examples of some other unique features and embodiments of the system and method of the present invention include, for example, full capability of on-line ordering after customer's profile has been approved by supplier; direct debit (fixed terms per area, 30 days after date of invoice (DDI)); below average price; at least two currencies; web self-help TS; online products specifications, MSDS, and Certification of Analysis; automated order confirmation and invoice issuance; updated FAQ (interactive); protected area with sign on; live service, but at a cost; pre-set up for EH&S, and credit; credit check on first order; no price stability; and covers worldwide system including, for example, Europe (Western and Central) and North America, Japan, SE Asia, Latin America, Middle East and Turkey, South Korea, Brazil, CAPU (Chile, Argentina, Paraguay, Uruguay).

Optionally, other products and extra features that the system and method of the present invention can offer or other business rules that can be included in the present invention include for example, price comparisons off other sites; last trades; credit card transaction capability; loyalty cards/offers; special offers; live auctions; industry news; satisfaction surveys for third parties passes off to distributors; pacific and Latin American area information; yen currency for Japan; dial your own blend facility; smaller lots available; rush orders; credit card accepted; and loyalty program offered.

Another embodiment of the present invention is to provide registered customers who use the web site with a secure and private transaction environment by using a Secure Socket Server which incorporates the latest in data-encryption technology. Information, regarded as confidential, is stored on the web site and can only be accessed via a password and Secure Socket Layer (SSL). This secured system protects customer confidential data so that the information is only transferred over an encrypted link. Registered customers can only access customer data via a specially designed “maintenance application”, which also prevents confidential information, e.g. individual price agreements for orders, being transferred, un-protected over the Internet. The web site of the present invention provides a secure transactional capability enabling registered customers, utilizing a password, to enter orders on a browser-based system, which generates an e-mail order to a functional mailbox. Supplier's registered customers may view the customer's own account details and check on customer's own manually updated order status.

In another embodiment, the system and method of the present invention provides supplier with the ability to selectively offer one or more of its customers special offers or promotion code (“promo codes”); and to change net unit price of a product. An example is shown in FIG. 8A. The current price on the web site is used to estimate the invoice value (net of duties and taxes) for the customers. In addition, proprietary application of logic can increase the unit price to allow for smaller shipments and also allow the use of promo codes to reduce the net price. Promo codes may be assigned by customer, by product, by region (web page) or by time-frame; and may be delivered and administered by email.

The web site advantageously has the flexibility to be expanded to include additional manufacturers and products, particularly supplier partners for complementary products. Other producers or suppliers who can not afford to build their own site can join the host web site of the present invention for a fee in order to share the site. Therefore, in another embodiment of the present invention, a plurality of suppliers may be added to a controlling host web site, owned by a “host supplier”, to expand the product offering of the web site with products that are complementary to each other. For example, the “associate suppliers” sign a contract with the “host supplier” and the associate suppliers agree that all transactions entered into by the associate supplier involving use of the site are directly between the associate supplier and its customers; and that the web site acts only as an intermediary. The associate supplier also usually agrees that the associate supplier's acceptance or rejection of any order shall be at associate supplier's sole discretion, liability and account. In addition, usually the host supplier agrees not to represent any customers and not to make any representation regarding any customers, for example any representation regarding the creditworthiness of any customers. Generally, the host supplier takes no title to, and does not take possession of, any products sold by associate supplier through the web site. Generally, the host supplier, by agreement with the associate supplier, has no obligation or liability to the associate supplier with respect to any matters relating to the sale of any products, the provision and use of any services, or the payment or non-payment of any fees or amounts by a customer to the associate supplier.

When there are more than one supplier on the portiche, generally, the order process includes the following steps: All associate supplier's customers enter orders on the web browser over the web site as described above. Preferably, the host supplier generates an e-mail order that is forwarded within 24 hours, during normal working days, to associate supplier's designated order entry system. The associate supplier then notifies the host supplier within 24 hours, during normal working days, of the associate supplier's acceptance or rejection of the order.

Generally, the associate supplier is solely responsible for accepting or rejecting orders, fulfilling accepted orders, invoicing, evaluating customer's ability to safely handle the ordered product, and taking the credit risk associated with the order. Preferably, the associate supplier provides an order status to the host supplier who will update the order status on the web site for viewing by the customer. Status categories include, for example, (1) “order received”, (2) “order confirmed” or “order rejected” and (3) “order shipped.”

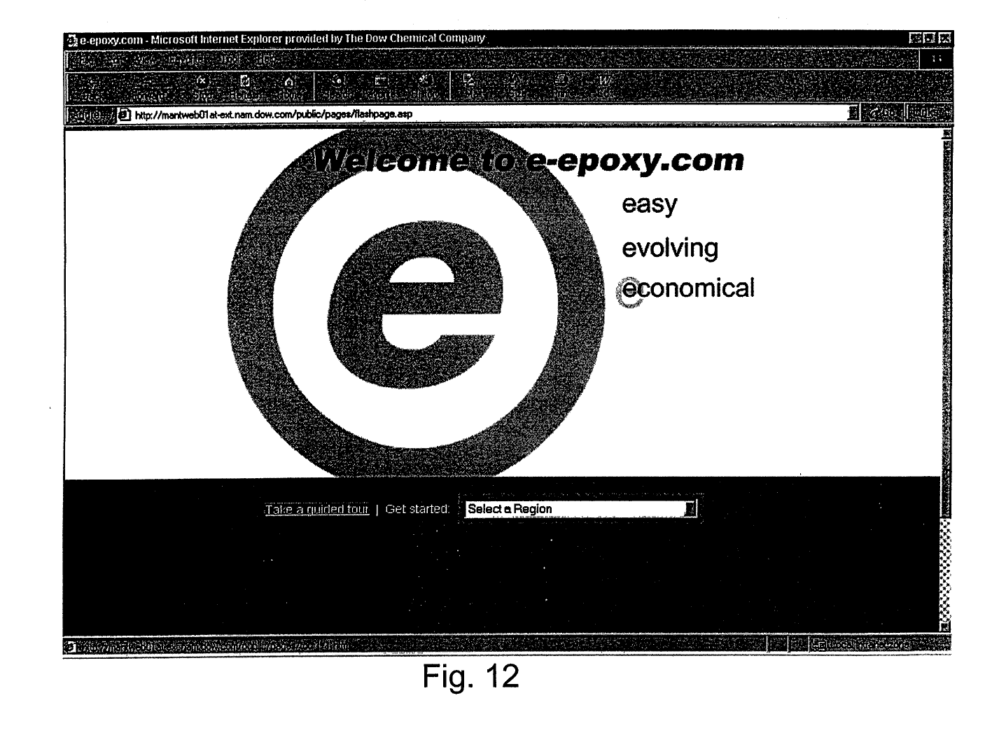

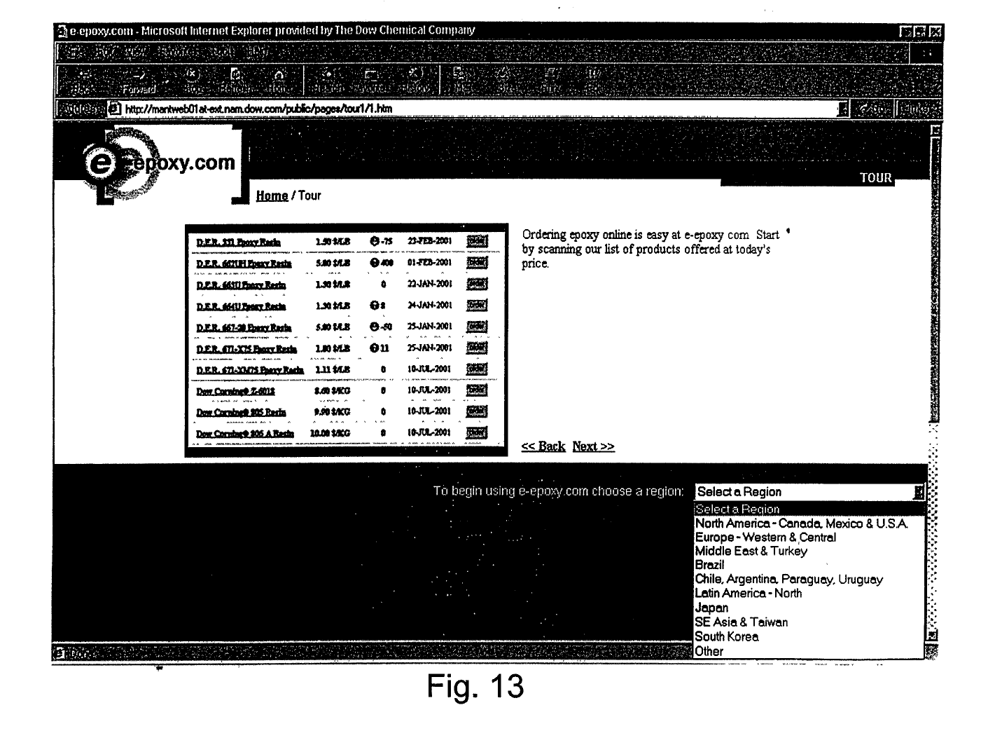

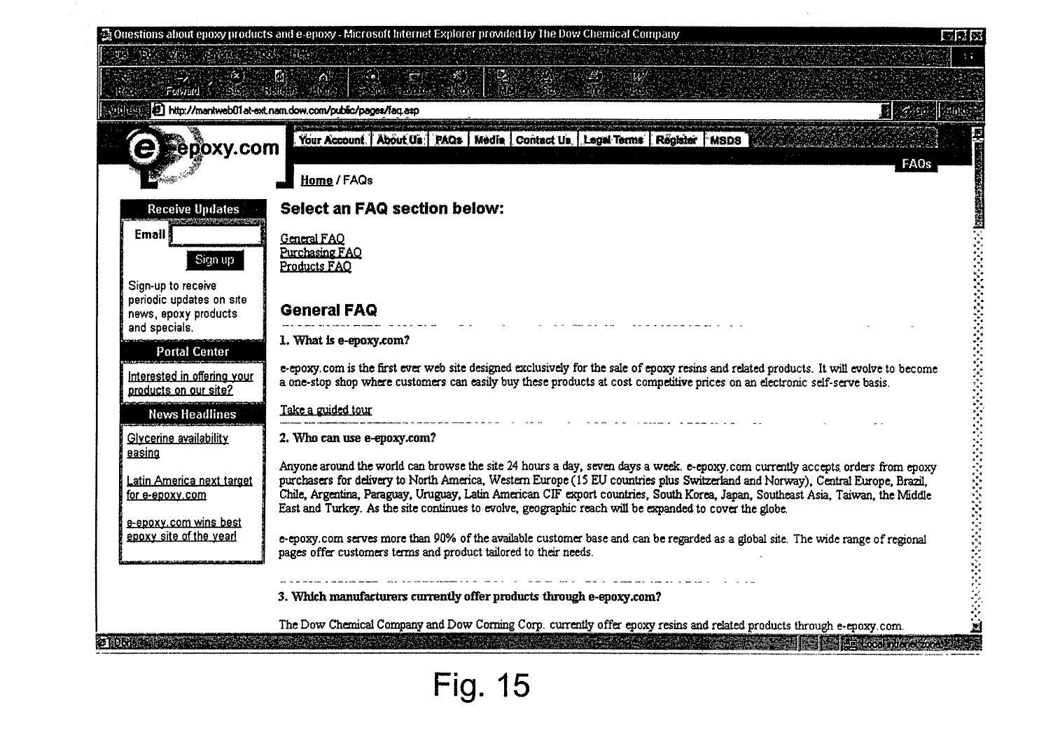

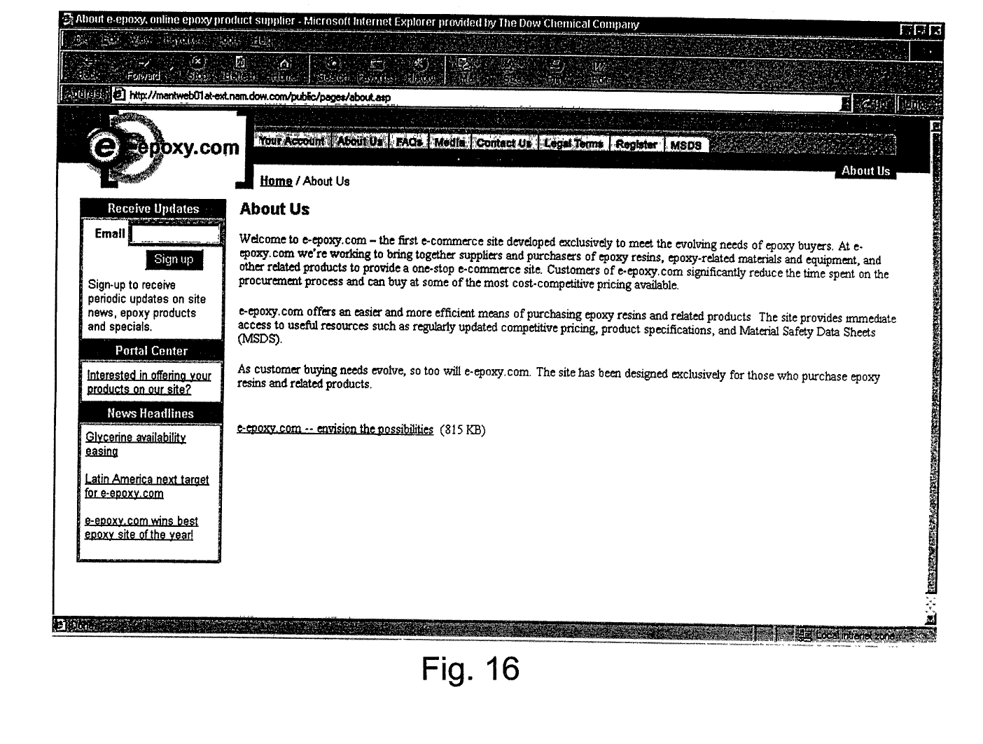

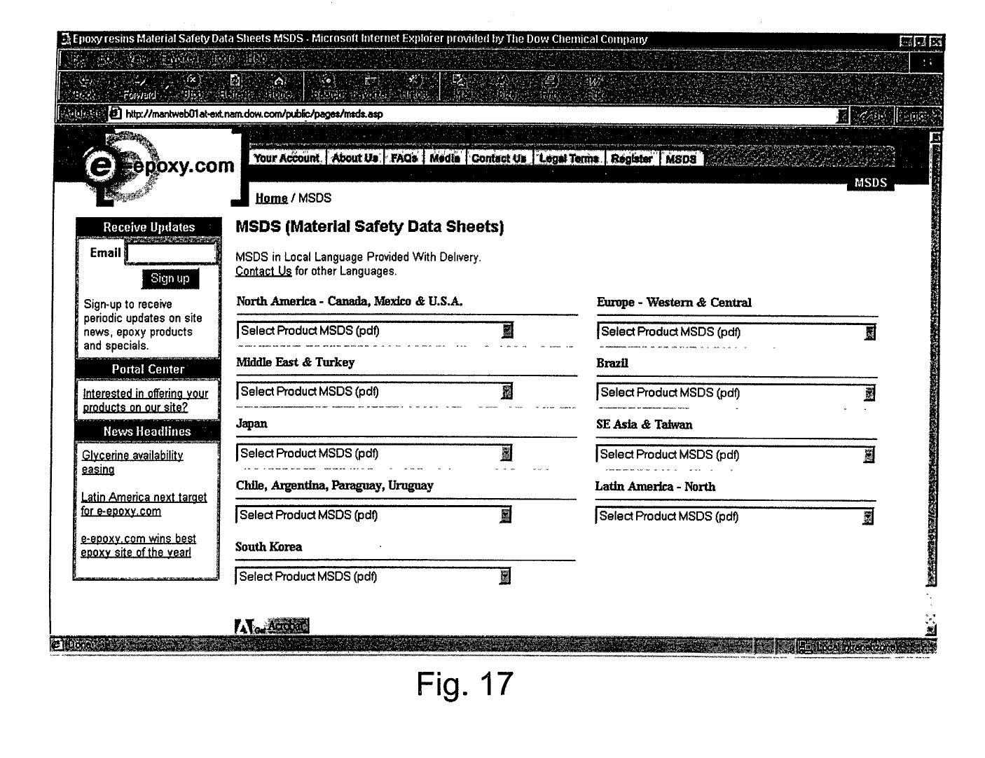

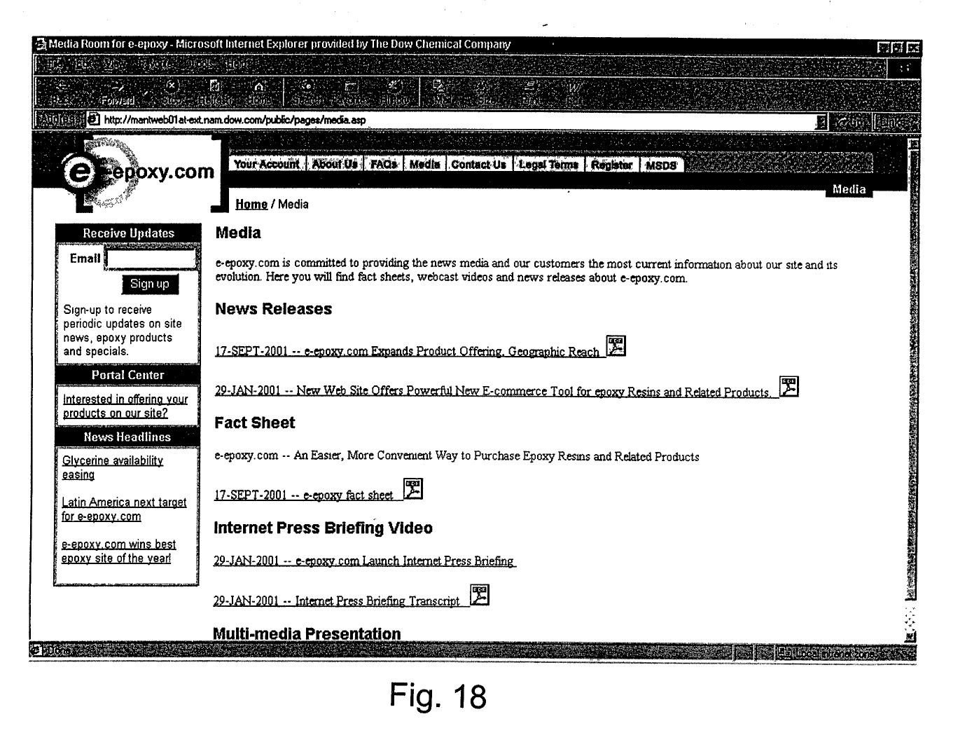

Other optional features of the web site are illustrated in screen FIGS. 12-18. These web pages are preferred embodiments, and it is understood by one skilled in the art that modifications can be made to such web pages without departing from the spirit and scope of the present invention. For example, FIG. 12 shows an introductory initial flash page to introduce the web site to the user. FIG. 13 provides the user with a tour page to allow users to familiarize themselves with the web site. FIG. 14 is an example of a “Contact Us” web page to allow a user to communicate with the host supplier via e-mail. FIG. 15 shows an example of a web page for frequently asked questions by users. FIG. 16 shows an example of a web page with information about the web site. FIG. 17 is an example of a web page including links to MSDS in languages for specific regions of the world. FIG. 18 shows an example of a media web page with links to various news stories and news articles related to the products of and suppliers of the web site.

The web site of the present invention offers multiple purchasing options that allow users to access both traditional channels and other online channels in a secure and private transaction environment. In return for this convenience, however, users must follow the essence of the pre-established business rules, discussed above. The system and method of the present invention allows differentiation from existing direct and distribution channels and therefore minimizes channel conflict.

The E-commerce system and method of the present invention is leading to changes in the way chemical companies do business. The portiche of the present invention has many advantages over previously known systems, for example, the web site's standardized business rules such as set purchase quantities, e.g., truckload and half-truckload; and one set of payment terms on offer is advantageously streamlining transactions between customers and suppliers.

The above-described preferred embodiments of the system and method of the present invention is merely illustrative of the principles of the present invention. Numerous modifications and adaptations thereof will be readily apparent to those skilled in the art without departing from the spirit and scope of the present invention as claimed in the following claims.

What is claimed is:

1. A web-based method of buying and selling a commodity-type product useful in manufacturing and processing industries comprising:
(a) providing a web site system offering products and services that includes a browsable catalog of the products and that provides services for allowing customers to electronically choose and purchase the products at a pre-established price and on a self service basis;
(b) requiring the customer to agree to an initial purchase agreement for said products, said purchase agreement containing a first set of pre-established terms and conditions and a second set of surcharge-bearing terms and conditions which are activated and implemented upon the customer requesting modification of the first set of terms and conditions after the initial purchase order is submitted electronically by the customer and accepted by the manufacturer of said products;
(c) transacting a sale of the product(s) of the catalog with the customer through the web site system; and
(d) completing the transaction by fulfilling the purchase order based on the initial purchase agreement or any modification thereof.

2. A web-based sales system to allow an Internet user to purchase a commodity-type product useful in manufacturing and processing industries comprising:
(a) a web site system offering products and services that includes a browsable catalog of the products and that provides services for allowing customers to electronically choose and purchase the products at a pre-established price and on a self-service basis;
(b) an initial purchase agreement for said products, said purchase agreement required to be agreed to by the customer, said purchase agreement containing a first set of pre-established terms and conditions and a second set of surcharge-bearing terms and conditions which are activated and implemented upon the purchaser requesting modification of the first set of terms and conditions after the initial purchase order is submitted electronically by the customer and accepted by the manufacturer of said products;
(c) means for transacting a sale of the product and/or other products of the catalog with the customer through the web site system; and
(d) means for completing the transaction and fulfilling the purchase order based on the initial purchase agreement or any modification thereof.

3. The method of claim 1 wherein the web site is constantly active.

4. The method of claim 1 including transmitting to the customer a confirmation that the order has been received.

5. The method of claim 1 including transmitting to the customer a confirmation that the order has either been confirmed or rejected.

6. The method of claim 1 including transmitting to the customer a confirmation that the order has been shipped.

7. The method of claim 1 including receiving and processing payment for the product purchased by the customer.

8. The method of claim 7 including transmitting to the customer a confirmation that the payment has been received.

9. The method of claim 1 including a plurality of different products from a plurality of different manufacturers.

10. The method of claim 8 including having each manufacturer fulfill each of their own products after the initial order is received via the web site.

11. The method of claim 1 wherein the initial terms and conditions of the contract include quantity, price, use of promo code (where decided appropriate by manufacturer) and delivery.

12. The method of claim 1 including the step of registering the customer electronically on the web site.

13. The method of claim 1 including the step of providing promo codes for certain products.

14. The method of claim 1 including the step of applying a surcharge to a particular order or subsequent order.

15. The method of claim 1 including the step of communicating the differentiated business rules per channel to the industry, via media, sales, distributors, agents, e-mail, advertising, or by word-of-mouth.

16. The method of claim 1 including the step of enforcing the differentiation of business rules and discipline to enforce surcharges where appropriate to enforce said differentiation.

17. The method of claim 1 including the step of providing one set of global business rules and terms and conditions in English and translating the English language into one or more different languages.

18. A method of selling a bulk chemical product comprising:
(a) providing a web site system offering bulk chemical products that includes a browsable catalog of the bulk chemical products and that provides services for allowing customers to electronically purchase the products;
(b) receiving orders electronically via the web site system;
(c) providing a customer with a business agreement with a set business rules specifying legal terms for purchasing the products;
(d) sending confirmation of order to the customer after customer accepts the business agreement;
(e) transacting a sale of the products and/or other items of the catalog with the customer through the web site system;
(f) shipping out product to the customer through normal distribution channels;
(g) sending confirmation of shipment to the customer;
(h) sending confirmation of customer receiving order to the customer after customer receives and accepts shipment of product;
(i) receiving and processing payment for product by customer; and
(j) sending confirmation of payment to the customer.

19. A method of selling product by multiple manufacturers of bulk chemical products via the Internet in e-commerce comprising:
(a) establishing a host web site for product offerings;
(b) signing manufacturers onto the host web site;
(c) taking orders from customers at pre-established contract terms and conditions;
(d) fulfilling orders at the established contract price; and
(e) delivering product to the customers by normal distribution channels.

20. A method of selling a bulk chemical product comprising:
(a) establishing a web site system offering products that includes a browsable catalog of bulk chemical products and that provides services for allowing customers to electronically purchase the products;
(b) receiving orders electronically via the web site system;
(c) providing the customer with a business contract with a set of pre-established business rules specifying legal terms for purchasing items;
(d) sending confirmation of order to the customer after customer accepts contract;
(e) transacting a sale of the product and/or other items of the catalog with the customer through the web site system;
(f) shipping out product to the customer through normal distribution channels;
(g) sending confirmation of shipment to the customer;
(h) sending confirmation of customer receiving order to the customer after customer receives and accepts shipment of product;
(i) receiving and processing payment for product by customer; and
(j) sending confirmation of payment to the customer.

21. A method of selling product by multiple manufacturers of bulk chemical products via the Internet in e-commerce comprising:
(a) establishing a host web site;
(b) signing manufacturers onto the web site;
(c) taking orders from customers at a pre-established contract terms and conditions;
(d) fulfilling orders at the established contract price; and
(e) delivering product by normal distribution channels.
